(19) United States
(12) Patent Application Publication
(10) Pub. No.: US 2023/0389572 A1
(43) Pub. Date: Dec. 7, 2023

(54) FOOD COMPOSITIONS AND APPLICATIONS THEREOF

(71) Applicant: MARS, INCORPORATED, McLean, VA (US)

(72) Inventor: Nicolas M. LEROUXEL, Aimargues (FR)

(73) Assignee: MARS, INCORPORATED, McLean, VA (US)

(21) Appl. No.: 18/246,488

(22) PCT Filed: Sep. 17, 2021
(86) PCT No.: PCT/US2021/050778

§ 371 Date: Mar. 23, 2023

(30) Foreign Application Priority Data
Sep. 24, 2020 (EP) 20198127.1

(51) Int. Cl. A23K 20/111; A23K 50/42

(52) U.S. Cl. CPC A23K 20/111; A23K 50/42

(57) ABSTRACT

The present disclosure relates to a food composition, product thereof and kits; including a combination of: (i) a camosic acid source, (ii) a hydroxytyrosol source, and (iii) a tannin source. The disclosure also relates to such food compositions, products and kits for use as a preservative and/or for use as a medicament, in particular in a method for eliciting or increasing an immune response of an animal.

### CROSS-REFERENCE TO RELATED APPLICATIONS

This application claims priority to European patent application no. EP 20198127.1 filed on Sep. 24, 2020, which is incorporated herein by reference in its entirety.

### FIELD OF THE DISCLOSURE

The present disclosure relates to the field of food compositions, especially food additives, and therapeutic methods. Those food compositions are particularly convenient for companion animals, and especially pets. Advantageously, the present disclosure relates to a food composition having dual properties, as a preservative and for health improvement, alone or in the form of a companion animal food product.

### BACKGROUND OF THE DISCLOSURE

Food products can become rancid as the fats in the food product undergo chemical as well as physical changes. Lipid oxidation is a common undesirable chain reaction consisting of three main phases: initiation, propagation and termination. During this oxidation process, unsaturated fatty acids are slowly oxidized. As a result, a series of breakdown products are produced, which can lead to a rancid flavour with less palatability of the food.

This phenomenon can cause nutritional risks, in particular for animals such as pets. In particular, rancid food products are less nutritious because oxidation destroys the good fats and some of the vitamin content. Experts agree that regular consumption of rancid food products or oils from time to time could contribute to the development of inflammatory diseases, cardiovascular illness, depression of growth, bone formation and immune function and even certain cancers. In order to extend the shelf life of food products and to overcome these nutritional problems, it is useful to add antioxidants to susceptible materials. Antioxidants are classified as feed additives (European Union Register of Feed Additives, Annex I of Regulation (EC) No. 1831/2003) and defined as substances that delay the oxidative degradation processes of food compositions and thus improve oxidative stability.

In animal food, such as pet food composition, these antioxidants primarily include propyl gallate, butylated hydroxyanisole (BHA), and butylated hydroxytoluene (BHT) as synthetic antioxidants. However, these synthetic antioxidants do not have any nutritional activities and are suspected to be carcinogens or endocrine disruptors.

As a precautionary principle, some food compositions have replaced synthetic preservatives by antioxidant systems based generally on mixed tocopherol of natural origin only. These natural preservative systems based on tocopherol are less efficient than synthetic systems for reducing lipid oxidation in food compositions, such as dry food compositions, i.e., kibbles.

WO2017/085099 describes a combination of natural antioxidants that enhances the antioxidant effect of tocopherols in a fat-containing composition, including tocopherols, carnosic acid and hydrolysable gallotannins.

Martinez et al. (Antioxidant and Antimicrobial Activity of Rosemary, Pomegranate and Olive Extracts in Fish Patties; Antioxidants; 2019) describes that Pomegranate, Rosemary and olive extracts (which are prone to contain phenolic compounds such as hydroxytyrosol) can act as antioxidant and microbial agents in food compositions as a substitute for synthetic additives.

Nevertheless, these preservatives systems based on tocopherols are less efficient than synthetic systems for reducing lipid oxidation, which can then lead to an impaired freshness of the product, with increased rancidity, which can then lead to product refusals, vomiting, diarrhea, and/or nutritionally unbalanced food compositions. Indeed, natural antioxidants tend to be less stable than synthetic antioxidants.

WO2012/125772 describes oral formulations including natural antioxidants that promote cellular detoxication and attenuates inflammation.

Most notably, the pet food industry is currently concerned about the use of natural antioxidants because of their potential negative influence on food palatability to pets.

Nevertheless, these food products do not present specific preservation activity and are not palatable.

There is thus a need for novel food compositions with increased antioxidant properties, increased stability, and which are also convenient for the preparation of companion animal food products.

There is a need for novel food compositions as a preservative for a companion animal food product.

There is a need for novel food compositions which also retain the palatability of the companion animal food products, over time.

There is a need for novel food compositions which include natural sources and/or which are devoid of synthetic additives.

There is a need for novel food compositions which include lesser amounts of tocopherols, or even which are devoid of such tocopherols.

There is also a need for novel food compositions which do not impair the palatability, and overall acceptance and aspect, of companion animal food compositions; especially those which are meant to be administered to pets such as dogs and cats.

There is a need for novel companion animal food products which increase a vaccine response of a companion animal.

There is a need for novel companion animal food products which elicit or increase an immune response of a companion animal.

There is a need for novel food products which prevent or reduce the likelihood of occurrence of a condition of a companion animal selected from: cellular oxidative stress and inflammation.

The present disclosure has for purpose to satisfy all or part of the above-mentioned needs.

### SUMMARY OF THE DISCLOSURE

The purpose and advantages of the disclosed subject matter will be set forth in and are apparent from the description that follows, as well as will be learned by practice of the disclosed subject matter. Additional advantages of the disclosed subject matter will be realized and attained by the devices particularly pointed out in the written description and claims hereof, as well as from the appended drawings.

To achieve these and other advantages and in accordance with the purpose of the disclosed subject matter, as embodied and broadly described, the disclosed subject matter includes a combination of several plant extracts which has demonstrated to be more efficient than tocopherols and as efficient as synthetic antioxidants while being palatable for antioxidant properties and/or therapeutic purposes.

This dual-effect can thus be particularly convenient, especially in the pet food industry. Surprisingly, the present disclosure herein shows that a natural antioxidant composition according to the disclosure cannot negatively impact the palatability of companion animal food products to pets, such as cats and dogs.

According to a first aspect, the present disclosure is directed to a food composition including at least a combination of an effective amount of: (i) a carnosic acid source; (ii) a hydroxytyrosol source; and (iii) a tannin source.

In certain embodiments, at least one of (i) the carnosic acid source, (ii) the hydroxytyrosol source and (iii) the tannin source can each be present in an amount of less than about 40 ppm; in particular in an amount ranging from about 3 ppm to less than about 40 ppm. In such an exemplary embodiments, the tannin source can be present in an amount of less than 40 ppm.

In certain embodiments, at least two of (i) the carnosic acid source, (ii) the hydroxytyrosol source and (iii) the tannin source can each be present in an amount of less than about 40 ppm; in particular in an amount ranging from about 3 ppm to less than about 40 ppm.

In certain embodiments, the carnosic acid source, the hydroxytyrosol source and the tannin source can each be present in an amount of less than about 40 ppm; in particular in an amount ranging from about 3 ppm to less than about 40 ppm.

In certain embodiments, the total combined amount of the carnosic acid source, the hydroxytyrosol source and the tannin source can be of less than about 40 ppm; in particular in an amount ranging from about 3 ppm to less than about 40 ppm.

In certain embodiments, the tannin source can include a hydrolysable tannin source. In certain other embodiments, the tannin source can include a gallotannin source and/or an ellagitannin source. In certain other embodiments, the tannin source can include a tannic acid source, an ellagic acid source, a gallic acid source, or a combination thereof. In certain particular embodiments, the tannin source can be a tannic acid source. In certain other particular embodiments, the tannin source can be a gallic acid source. In certain other particular embodiments, the tannin source can be a combination of a tannic acid source and a gallic acid source. In certain embodiments, a tannic acid:gallic acid ratio can range from about 1:5 to about 1:50. In certain particular embodiments the tannic acid:gallic acid ratio can be from about 1:10 to about 1:40. In certain particular embodiments, the tannic acid:gallic acid ratio can be from about 1:15 to about 1:30.

In certain embodiments, the food composition of the present disclosure does not include tocopherol. In certain particular embodiments, the food composition of the present disclosure does not include gamma and/or delta tocopherol.

In certain embodiments, the carnosic acid source can be a rosemary extract.

In certain embodiments, the hydroxytyrosol source can be an olive extract.

In certain embodiments, the tannin source can be a gallnut extract.

In certain embodiments, the present disclosure relates to a food composition including at least a combination of an effective amount of: (i) a rosemary extract; (ii) an olive extract; and (iii) a gallnut extract.

In certain embodiments, the food composition can be a functional food, a dietary, a food additive, a food preservative, a supplement, a drug, a foodstuff, or a nutritionally complete food composition.

According to another aspect, the present disclosure provides a companion animal food product including a food composition as defined above.

In certain embodiments, the companion animal food product can include the tannin source in an amount ranging from at least about 3 ppm to less than about 40 ppm.

In certain embodiments, the companion animal food product does not include tocopherol.

In certain embodiments, the companion animal food product can be a nutritionally complete food product.

According to another aspect, the present disclosure provides a kit for the preparation of a companion animal food product, including: (i) a carnosic acid source; (ii) a hydroxytyrosol source; and (iii) a tannin source. In certain embodiments, the tannin source can include a hydrolysable tannin source. In certain embodiemtns, the tanning source can include a gallotannin source and/or an ellagitannin source. In certain other embodiments, the tannin source can include a tannic acid source, an ellagic acid source, a gallic acid source, or a combination thereof In certain particular embodiments, the tannin source can be a tannic acid source. In certain other particular embodiments, the tannin source can be a gallic acid source. In certain other particular embodiments, embodiments, the tannin source can be a combination of a tannic acid source and a gallic acid source; in certain embodiments, a tannic acid:gallic acid ratio can range from about 1:5 to about 1:50. In certain particular embodiments the tannic acid:gallic acid ratio can be from about 1:10 to about 1:40. In certain particular embodiments, the tannic acid:gallic acid ratio can be from about 1:15 to about 1:30.

According to another aspect, the present disclosure is directed to the use of a food composition, product or kit as defined in the present disclosure as a preservative for a companion animal food product.

According to another aspect, the present disclosure is directed to a food composition, product or kit as defined in the present disclosure for use as a medicament.

According to another aspect, the present disclosure is directed to a food composition as defined in the present disclosure for use in a method for eliciting or increasing an immune response of a companion animal, or for preventing or reducing the likelihood of occurrence of an infection and/or an allergic reaction of a companion animal.

In certain embodiments, the food composition as defined in the present disclosure can be used in a method for eliciting or increasing an immune response toward a viral or bacterial or parasitic infection.

In certain embodiments, the food composition as defined in the present disclosure can be used in a method for preventing, or reducing the likelihood of occurrence of a condition of a companion animal selected from the group consisting of cellular oxidative stress and inflammation. In certain particular embodiments, the food composition as defined in the present disclosure can be used to reduce DNA damage.

In certain embodiments, the companion animal can be a pet. In certain particular embodiments, the pet is a canine or a feline. In certain particular embodiments, the pet is a dog or a cat. In certain particular embodiments, the pet is an older dog or an older cat.

According to another aspect, the present disclosure provides a method for manufacturing an animal food product, which includes the step of mixing (i) a carnosic acid source; (ii) a hydroxytyrosol source; and (iii) a tannin source.

In certain embodiments, the method of manufacturing an animal food product can include the steps of: a) providing an extrudate of a combination of (i) a hydroxytyrosol source and of (ii) a tannin source; and b) coating said extrudate with a carnosic acid source.

In certain embodiments, the present disclosure provides a method for maintaining the PV (Peroxide Value) of a companion animal food product, said method including the step of bringing into contact the said companion animal food product with a combination of (i) a carnosic acid source; (ii) a hydroxytyrosol source; and (iii) a tannin source. In certain embodiments, the PV of the companion animal food product is below 10 mEq/kg fat for at least 12 months. In certain embodiments, (i) the carnosic acid source is present in the said companion animal food product in an amount of less than about 40 ppm, (ii) the hydroxytyrosol source is present in said companion animal food product in an amount of less than about 40 ppm, and (iii) a tannin source is present in said companion animal food product in an amount of less than about 40 ppm.

In certain other embodiments the present disclosure provides a method for maintaining the hexanal value of a companion animal food product, said method including the step of bringing into contact the said companion animal food product with a combination of (i) a carnosic acid source; (ii) a hydroxytyrosol source; and (iii) a tannin source. In certain embodiments the hexanal value of the companion animal food product is below about 15 ppm for at least about 12 months. In certain embodiments (i) the carnosic acid source is present in said companion animal food product in an amount of less than about 40 ppm, (ii) the hydroxytyrosol source is present in said companion animal food product in an amount of less than about 40 ppm, and (iii) the tannin source is present in said companion animal food product in an amount of less than about 40 ppm.

In certain other embodiments, the present disclosure provides a method for treating or preventing or reducing the likelihood of occurrence of a cellular oxidative stress, the method including: providing a food composition or companion animal food product or kit including at least a combination of an effective amount of (i) a carnosic acid source, (ii) a hydroxytrosol source, and (iii) a tannin source; and administering to the companion animal an effective amount of the food composition or companion animal food product or kit.

In certain embodiments, the present disclosure provides a method for treating or preventing or reducing the likelihood of occurrence of a cellular oxidative stress, the method comprising: providing a food composition or companion animal food product or kit including at least a combination of an effective amount of (i) a carnosic acid source, (ii) a hydroxytrosol source, and (iii) a tannin source; and administering to the companion animal an effective amount of the food composition or companion animal food product or kit.

In certain embodiments, the present disclosure provides a method for treating or preventing or reducing the likelihood of occurrence of inflammation or an inflammatory disorder, the method including: providing a food composition or companion animal food product or kit comprising at least a combination of an effective amount of (i) a carnosic acid source, (ii) a hydroxytrosol source, and (iii) a tannin source; and administering to the companion animal an effective amount of the food composition or companion animal food product or kit.

In certain embodiments, the present disclosure provides a method for eliciting or preventing in a companion animal an immune response, the method comprising: providing a food composition or companion animal food product or kit including at least a combination of an effective amount of (i) a carnosic acid source, (ii) a hydroxytrosol source, and (iii) a tannin source; and administering to the companion animal an effective amount of the food composition or companion animal food product or kit.

In certain embodiments, the present disclosure provides a therapeutic method as defined above, such as for preventing or reducing the likelihood of occurrence of an infection and/or an allergic reaction in a companion animal, the method including a) providing a food composition or companion animal food product or kit comprising at least a combination of an effective amount of (i) a carnosic acid source, (ii) a hydroxytrosol source, and (iii) a tannin source; and b) administering to the companion animal an effective amount of the food composition or companion animal food product or kit.

### DETAILED DESCRIPTION OF THE DISCLOSURE

The present disclosure aims at making available a food composition for the preservation of companion animal food products. The present disclosure aims also at making available a food composition that can have a therapeutic health benefit. The present disclosure also aims at making available a food composition for the preservation of companion animal food products that also can have a therapeutic health benefit.

It is provided herein a food composition for a companion animal food product including at least a combination of an effective amount of a carnosic acid source, an hydroxytyrosol source and a tannin source.

In certain embodiments, this combination is slowing down rancidity in food products. In certain embodimentsembodiments, this combination is eliciting or increasing an immune response of a companion animal, or preventing or reducing the likelihood of occurrence of an infection and/or an allergic reaction of a companion animal. In certain embodimentsembodiments, this combination can exercise both activities: slowing down rancidity in food products and eliciting or increasing an immune response of a companion animal or preventing or reducing the likelihood of occurrence of an infection and/or an allergic reaction of a companion animal.

Surprisingly, it has been found that a combination of an effective amount of a carnosic acid source, an hydroxytyrosol source and a tannin source is more efficient than mixed tocopherols as a food preservative, and at least as efficient as reference synthetic antioxidants (such as Propyl gallate, BHA, BHT, ethoxyquin, TBHQ etc.), while maintaining good palatability of the final companion animal food product. Further, it has been also found that this combination can be also used as a medicament, such as a medicament for eliciting or increasing an immune response of a companion animal. In certain embodiments, this combination can be also used as a functional nutritional food, such as a functional nutritional food for eliciting or increasing an immune response of a companion animal.

Advantageously, this food composition of active ingredients can also be derived from natural sources, such as plant extracts or sources and/or vegetables.

As provided in the present disclosure and illustrated in the examples, such a food composition can include, or consist of, a combination of an effective amount of several plant extracts in order to preserve raw materials, especially fat containing raw materials, and dry or wet finished products against rancidity spoilage. Moreover, as illustrated in the examples provided herein that such a preservation composition increases shelf-life of companion animal food products in paper bags or in modified atmosphere conditions (ATCO) while being palatable for companion animals.

As it is further provided in the present disclosure and shown in the examples provided herein, such a food composition can elicit or increase an immune response of a companion animal. In particular, in certain embodiments, such a combination can increase response to vaccines and increase proliferation of lymphocytes.

Hence, the present disclosure relates to a food composition or a kit for the preparation of a companion animal food product, including a combination of a carnosic acid source, an hydroxytyrosol source and a tannin source.

The present disclosure further provides a companion animal food product including food compositions of the present disclosure. These and other aspects of the present disclosure are discussed in further details below.

### Definitions

The terms used in this specification generally have their ordinary meanings in the art, within the context of this subject matter and in the specific context where each term is used.

Certain terms are defined below to provide additional guidance in describing the compositions and methods of the disclosed subject matter and how to make and use them.

As used in the specification and the appended claims, the singular forms “a”, “an”, and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

Moreover, the terms “at least” and “less than” encompass the hereafter cited value. For example, “at least 40 ppm” has to be understood as also encompassing “40 ppm”.

As used herein, the terms “animal” or “pet” can be used, for example, to refer to domestic or wild animals. In certain embodiments, the terms can refer to cats or felines, or dogs or canines.

As used herein, the term “amino acid source” means a material containing amino acids. Said amino acid source can include or be derived from, but is not limited to, plant proteins, animal proteins, proteins from single cell organisms and free amino acids.

As used herein, the term “animal protein” refers to animal-based sources of protein. Such animal protein includes, for example without limitation, meat (for example, pork, beef, or veal), poultry (for example, chicken), fish, organs (for example, liver, spleen, or heart), viscera (for example, viscera of chicken or pork), and combinations thereof.

As used herein, the term “antioxidant” refers to any molecule, composition or products which delays or prevents the oxidation of an animal food product, and in particular of an oxidizable fat. Preservative food compositions of the present disclosure prevent or inhibit the oxidation process. Further, preservatives of the disclosure preserve fresh attributes and nutritional quality of the animal food including it. Advantageously, the antioxidants which are present in such preservative food compositions consist exclusively of non-synthetic (i.e., natural) antioxidants.

As used herein, the term “synthetic antioxidant” refers to chemically synthesized, non-naturally occurring, compounds which can be added to food as preservatives to help prevent lipid oxidation. In a non-exhaustive manner, this term thus encompasses the following compounds: Butylated hydroxytoluene (BHT), butylated hydroxyanisole (BHA), TBHQ (tert-butylhydroxyquinone), propyl gallate (PG), dodecyl gallate (DG), octylgallate (OG) and chelating agent, such as ethylenediaminetetraacetic acid (EDTA).

As used herein, the term “natural antioxidant” refers to naturally-occurring compounds with antioxidant properties.

The “antioxidant” properties of a given product or composition (i.e., a preservative food composition of the present disclosure) can be assessed by determining its ability to delay or prevent the oxidation of a molecule such as a lipid, lipoprotein, protein or DNA, over a given length of time.

As used herein, the term “canine” encompasses animals, including pet selected in the group comprising recognized dog breeds (some of which are further subdivided), which can include afghan hound, airedale, akita, Alaskan malamute, basset hound, beagle, Belgian shepherd, bloodhound, border collie, border terrier, borzoi, boxer, bulldog, bull terrier, cairn terrier, chihuahua, chow, cocker spaniel, collie, corgi, dachshund, dalmatian, doberman, English setter, fox terrier, German shepherd, golden retriever, great dane, greyhound, griffon bruxellois, Irish setter, Irish wolfhound, King Charles spaniel, Labrador retriever, lhasa apso, mastiff, newfoundland, old English sheepdog, papillion, pekingese, pointer, pomeranian, poodle, pug, rottweiler, St. Bernard, saluki, samoyed, schnauzer, Scottish terrier, Shetland sheepdog, shih tzu, Siberian husky, Skye terrier, springer spaniel, West Highland terrier, whippet, Yorkshire terrier, etc.

As used herein, the term “companion animal” refers to a pet. Pets encompass dogs, cats, rabbits, hamsters, guinea pigs, rats and mice. Preferred In certain particular embodiments of the present specification pets herein are feline or canine, especially as dogs and cats.

As used herein, the terms “comprise”, “comprising”, “include”, “including”, or any other variation thereof, are intended to cover a non-exclusive inclusion, such that a process, method, article, or apparatus that comprises a list of elements does not include only those elements but can include other elements not expressly listed or inherent to such process, method, article, or apparatus.

In the detailed description herein, references to “embodiments,” “an embodiments,” “one embodiments,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.embodiments,embodiments,embodiments,

As used herein, a “food composition” refers to any molecules or substances, or combinations of blends thereof, that can be added to food products, including beverages, to prevent undesirable chemical changes. The term “food composition” encompasses the terms “natural antioxidant composition”, “preservative food composition”, “antioxidant combination” and “composition”.

As used herein, the term “companion animal food product” or “animal food” or “food product” or “product” or “diet” refers to a composition or product intended for ingestion by a companion animal or a pet. Animal food products can include, without limitation, any composition or product which is suitable for daily feed as well as treats, nutritionally balanced or not, and nutritionally complete or not. In certain embodiments such composition can contain proteins, carbohydrates and/or fats, which is used in the body of an organism to sustain growth, repair and vital processes and to furnish energy. Foods can also contain supplementary substances or additives, for example, minerals, vitamins and condiments (See Merriam-Webster's Collegiate Dictionary, 10th Edition, 1993).

Preservative food compositions and animal food products disclosed herein can be dry or wet food. In particular, animal food products or preservative food compositions can be dry animal food products or dry food compositions.

As used herein, the term “functional food” refers to a food product which provides nutritional components that are important for health maintenance. These functional food compositions contain compounds that are biologically active or bioavailable, such as probiotics, amino acids, multivitamins, and antioxidants, and often are found to be useful for the treatment of disease and disorders or the maintenance of normal health states.

As used herein, the terms “dry animal food product” or “dry preservative food composition” generally refer to a food product or composition having a moisture content of less than 12% by weight, relative to the total weight of the food product or composition, and commonly even less than 7% by weight, relative to the total weight of the food product or composition. Dry animal food products can be formed by an extrusion process. In some embodiments, a dry animal food product can be formed from a core and a coating to form a dry animal food product that is coated, also called a coated dry animal food product. It should be understood that when the term “dry animal food product” is used, it can refer to an uncoated dry animal food product or a coated dry animal food product. A dry animal food composition can be a kibble.

As used herein, the term “kibble” includes a particulate pellet like component of animal feeds, such as dog and cat feeds, typically having a moisture, or water, content of less than 12% by weight, relative to the total weight of the kibble. Kibbles can range in texture from hard to soft. Kibbles can range in internal structure from expanded to dense.

As used herein, the term “core”, or “core matrix”, means the particulate pellet of a dry animal food product, i.e., a kibble, and is typically formed from a core matrix of ingredients. The particulate pellet can be coated to form a coating on a core, which can be a coated dry animal food product. The core can be without a coating or can be with a partial coating. In an embodiment without a coating, the particulate pellet can include the entire dry animal food product. Cores can include farinaceous material, proteinaceous material, and mixtures and combinations thereof. In one embodiments, the core can include a core matrix of protein, carbohydrate, and fat.

As used herein, the term “coating” means a partial or complete covering, typically on a core, that covers at least a portion of a surface, for example a surface of a core. In one example, a core can be partially covered with a coating such that only part of the core is covered, and part of the core is not covered and is thus exposed. In another example, the core can be completely covered with a coating such that the entire core is covered and thus not exposed. Therefore, a coating can cover from a negligible amount up to the entire surface. In an embodiments, a preservative food composition of the disclosure can be suitable for the preparation of a dry animal food product by coating. For example, a carnosic acid source can be added to a dry animal food product by coating.

As used herein, an “extrudate” refers to any product, such as an animal food product, which has been processed by, such as by being sent through, an extruder or pelleting process. An extrudate can be dry or wet. In certain embodiments, an extrudate is a dry extruded product. In certain particular embodiments, an extruded product is a dry animal food product, in particular a kibble. In certain embodiments of extrusion, kibbles are formed by an extrusion processes wherein raw materials, including starch, can be extruded under heat and pressure to gelatinize the starch and to form the pelletized kibble form, which can be a core. Any type of extruder can be used, non-limiting examples of which include single screw extruders and twin-screw extruders.

Unless specifically stated otherwise, amounts (in particular amount in parts per million (ppm), or milliequivalents/kg (mEq/kg) fat) are expressed herein by weight of a product reference, for example a preservative food composition according to the disclosure. In the present disclosure, ranges are stated in shorthand, so as to avoid having to set out at length and describe each and every value within the range. Any appropriate value within the range can be selected, where appropriate, as the upper value, lower value, or the terminus of the range. For example, a range from 1 to 10 represents the terminal values of 1 and 10, as well as the intermediate values of 2, 3, 4, 5, 6, 7, 8, 9, and all intermediate ranges encompassed within 1-10, such as 2 to 5, 2 to 8, 7 to 10, etc.

The term “ppm” or “parts per million” is herein used according to its conventional meaning. More precisely, it refers herein to a weight amount relative to the total weight of the preservative food composition, or of the animal food product comprising the preservative food composition (mg/kg) (unless otherwise indicated).

As used herein, the term “feline” encompasses animals, including pet, selected in the group comprising cheetah, puma, jaguar, leopard, lion, lynx, liger, tiger, panther, bobcat, ocelot, smilodon, caracal, serval and cats. As used herein, cats encompass wild cats and domestic cats. In particular embodiments, the cats are domestic cats.

As used herein, the term “nutritionally complete” refers to animal food products that contain all known required nutrients for the intended recipient of the animal food product, in all appropriate amounts and proportions based, for example, on recommendations of recognized and competent authorities in the field of animal nutrition. Such foods are therefore capable of serving as a source of dietary intake to maintain life, without the addition of supplemental nutritional sources.

As used herein the term “nutritionally balanced” refers to an animal food product which, through a single or reference serving of the said food, provides a nutritionally desirable level of fat, protein or amino acid source, and dietary fiber. The term “nutritionally balanced”, as used herein, can thus refer to animal food products that can be nutritionally complete. Alternatively, “nutritionally balanced”, as used herein, can also refer to animal food products that are not nutritionally complete.

As used herein, the terms “palatability” or “palatable” refer to being desirable to the palate or taste. Further, the terms “palatability” or “palatable” as used herein refer to the extent to which a pet food product appeals to the palate or taste of an animal. This is suitable measured by feeding tests, e.g., difference tests or ranking tests. In certain embodiments, “palatability” can mean a relative preference for one food product over another. For example, when an animal shows a preference for one of two or more food products, the preferred food product is more “palatable”, and has “enhanced palatability” or “increased palatability”. In certain embodiments, the relative palatability of one food product compared to one or more other food products can be determined, for example, in side-by-side, free-choice comparisons, e.g., by relative consumption of the food products, or other appropriate measures of preference indicative of palatability, i.e. “the two-bowl test”.

As used herein, the term “protein source” can encompass “animal protein sources”, “plant protein sources”, or any other amino acid source, or combinations thereof.

Preservative food compositions of the present disclosure can further include synthetic or natural antioxidants. Advantageously, preservative food compositions can include lesser amounts of synthetic antioxidants. According to some embodiments, such preservative food compositions comprise minimal amounts of synthetic antioxidants. For example, such preservative food compositions can include synthetic antioxidants in amounts less than about 1 ppm.

As used herein, the terms “wet animal food product” or “wet preservative food composition” generally refer to a food product or composition having a moisture content of higher than 12% by weight, relative to the total weight of the food product or composition, and commonly even higher than 20% by weight, relative to the total weight of the food product or composition.

As used herein, the term “fat” refers to the total amount of digestible, partially digestible and nondigestible fats or oils that are present in the embodiments of the present disclosure; in particular the animal food products, and especially the animal food products for which fat oxidation should be prevented or delayed. As used herein, the terms “lipid”, “fat” and “oil” are synonymous.

The constituents of oils and fats are known in chemistry to possess a tendency to absorb and react with oxygen. The development of rancidity results primarily from the products formed during oxidation. The dissolved or absorbed oxygen usually reacts first to form peroxides. The development of peroxides is accelerated by moisture, heat, light or catalysts. Aldehydes, ketones and acids of lower molecular weight are formed in the further decomposition and these materials impart an undesirable odor and taste to the oil or fat.

For quality assessment, it exists a lot of method known by the skilled person, such as peroxide value determination (PV), hexanal value determination, ferric thiocyanate method (FTC), thiobarbituric acid method (TBA), anisidine index determination, conjugated dienes determination, or any method for determining the stability such as oxygen bomb or rancimat. According to a preferred embodiments, the determination of major primary products (i.e., hydroperoxides) resulting from lipid oxidation, as well as secondary compounds (including alkanes, alkenes, aldehydes, ketones, alcohols, esters, acids and hydrocarbons) can thus be used to assess antioxidant properties. In a non-exhaustive manner, those antioxidant properties can thus be assessed by determining a “peroxide value” (PV), or an “hexanal value”.

As used herein “peroxide value” (PV) refers to the marker for fatty acids primary oxidation degradation compounds. Otherwise said, PV is used for the quantification of primary fat-oxidation products. Peroxide values of fresh food products are less than about 10 milliequivalents/kg (mEq/kg) whereas when the peroxide value is between about 20 and about 40 mEq/kg, the food product is considered rancid. According to a preferred embodiments, these values must be determined at end of shelf-life. According to an embodiments, a value up to 10 mEq/kg will be considered as rancid. Methods to analyze the PV of an animal food product are well known by the skilled person. Illustratively, the skilled person can use the NF EN ISO 3960 (Version of April 2017), the entirety of which is hereby incorporated herein by reference.

As used herein “hexanal value” refers to the marker for fatty acids second oxidation degradation compounds. Hexanal values of fresh food products are less than about 15 ppm whereas when the hexanal value is between about 15 and about 40 ppm, the food product is considered rancid. According to a preferred embodiments, these values have also to be determined at end of shelf-life. According to an embodiments, a value up to 15 ppm will be considered as rancid. Methods to analyze the hexanal level of an animal food product are well known by the skilled person. Illustratively, the skilled person can use the AOCS method Cg 4-94 (AOCS. 1997), the entirety of which is hereby incorporated herein by reference.

When used herein the term “tocopherol” refers either to isomers gamma and/or delta of tocopherols and/or derivatives thereof. When referring to “tocopherols”, it is meant the combination gamma and delta tocopherols, such as those found in their natural form (whether in their esterified or non-esterified form) that are used for natural preservation for counteracting rancidity. When referring to “tocopherols”, it does not comprise Vitamin E used for nutritional purposes.

Vitamin E is a generic description for all tocopherol (Toc) and tocotrienol (Toc-3) derivatives. Tocopherols have a phytyl chain, while tocotrienols have a similar chain but with three double bonds at positions 3′,7′ and 11′. Both tocopherols and tocotrienols have four isomers, designated as α-, β-, γ- and δ-, which differ by the number and position of methyl groups on the chroman ring. All of these molecules possess antioxidant activity, although α-tocopherol (α-Toc) is biologically the most active. α-Tocopherol is the major vitamin E in vivo and exerts the highest biological activity. While γ- and δ-Tocopherols exert the highest preservative activity and are used for counteracting lipid oxidation in food products. Tocopherols are present in polyunsaturated vegetable oils and in the germ of cereal seeds, whereas tocotrienols are found in the aleurone and subaleurone layers of cereal seeds and in palm oils.

When used herein, the term “carnosic acid” refers to a phenolic diterpene with chemical formula C₂₄H₂₈O₄ and/or derivatives thereof. The term “carnosic acid” encompasses carnosic acid and/or carnosol (chemical formula C₂₀H₂₆O₄). The term “rosemary” refers either to all of the plant material (Rosmarinus officinalis) or to any extract, part, or extract of a part of the plant material, for example from the leaves or roots. Rosemary can include, in addition to carnosic acid (and carnosol), rosmarinic acid and/or rosmanol.

When used herein, the term “hydroxytyrosol” refers to 4-(2-Hydroxyethyl)-1,2-benzenediol (CAS number: 10597-60-1), with chemical formula C₈H₁₀O₃, and/or derivatives thereof, such as tyrosol, that can be obtained from vegetable source such as olive. The term “olive” refers to either to all of the plant material or to any extract, part, or extract of a part of from the plant material, for example from the leaves, fruit, pulp, kernel, vegetation water of olive oil production and/or oil of olive. Olive can include, in addition to hydroxytyrosol (and tyrosol), oleuropein and/or ligstroside.

When used herein, the term “tannin” refers to a range of natural and non-natural polyphenols which can generally be divided as “hydrolysable” or “non-hydrolysable” and/or “condensed” tannins, and/or alternatively include low molecular and monomeric tannins, such as those with a molar mass below 1000 Daltons. Accordingly, reference is made to the Review of Karamali Khanbabaee and Teunis van Ree (“Classification and Definition”; The Royal Society of Chemistry; 2001, the entirety of which is hereby incorporated herein by reference)—see DOI: 10.1039/b1010611—for a full report on the classification of tannins based on their structural properties.

When tannins are derived from plants, they are generally polyphenolic secondary metabolites, and are either (i) galloyl esters and their derivatives, in which galloyl moieties or derivatives thereof are attached to polyol-, catechin- and triterpenoid cores, or (ii) they are derived from oligomeric and/or polymeric proanthocyanidins, which can optionally possess interflavanyl coupling and substitution patterns. Accordingly, the term “tannin”, when used herein, can encompass “gallotannins”, “ellagitannins”, “complex tannins” and “condensed tannins”.

In particular, the term “hydrolysable tannin” can thus encompass gallotannins, ellagitannins, complex tannins and mixtures thereof. More particularly, the hydrolysable tannins generally consist of gallotannins and ellagitannins, or mixtures thereof.

According to some embodiments, gallotannins can consist of tannins in which galloyl units or meta-depsidic derivatives thereof are bound to one or more polyol-catechin- or triterpenoid units. Accordingly, such gallotannins generally include at least a polyphenolic and a polyol residue, such as a polyol residue derived from D-glucose in plant-derived gallotannins. For instance, gallotannins can be represented by the following formulas:

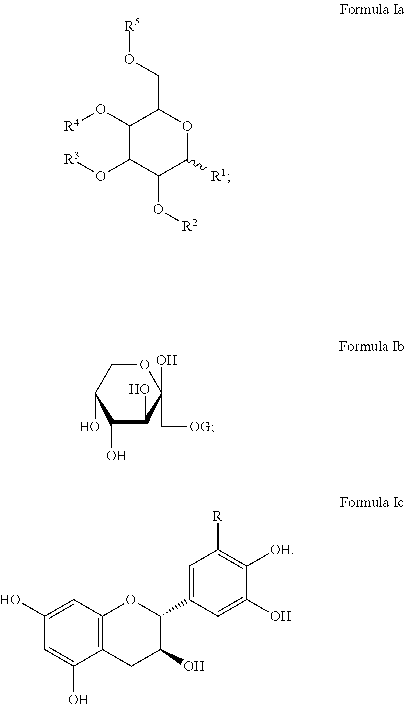

with R and R¹ being selected from α-OH, β-OH, α-OG and β-OG;

with R², R³, R⁴ and R⁵ being identical or different, and can be independently a galloyl moiety or any other substituent, such as but not limited to H, G, a cinnamoyl group and a coumaroyl group;

wherein G is:

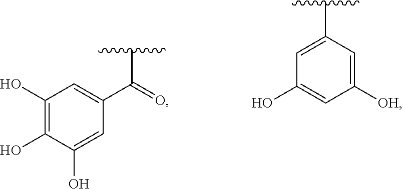 [SMILES: *C(=O)c1cc(O)c(O)c(O)c1 ; *c1cc(O)cc(O)c1]

or a meta-depsidic derivative thereof.

According to some embodiments, ellagitannins can be tannins in which at least two galloyl units are C—C coupled to each other, and do not contain a glycosidically linked catechin unit. Specific embodiments include but are not limited to, ellagitannins that have two galloyl units linked to each other through their aromatic carbon atoms to form an axially chiral hexahydroxydiphenoyl (HHDP) unit selected from:

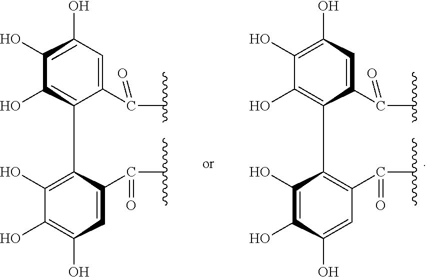

For instance, but not by the way of limitation, ellagitannin can be a compound represented by formula (II):

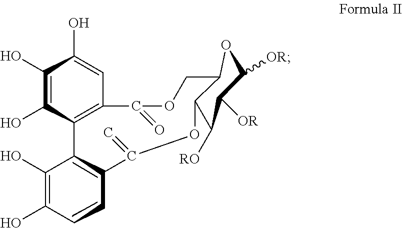

wherein each R is identical or different, and is independently selected from a galloyl moiety or any other substituent, such as but not limited to H, G, a cinnamoyl group and a coumaroyl group as defined above.

According to some embodiments, complex tannins are tannins in which a catechin unit is bound glycosidically to a gallotannin or an ellagitannin unit, such as those defined above. For instance, a complex tannin can be represented by formula (III):

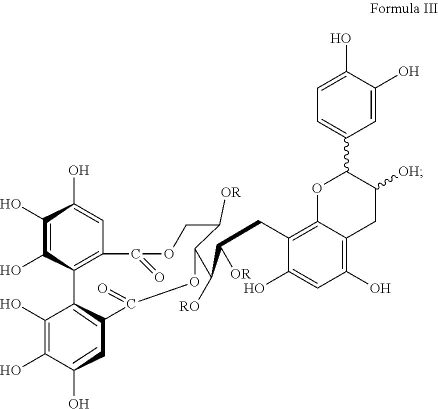

wherein each R is identical or different and can be independently selected from a galloyl moiety or any other substituent, such as but not limited to H, G, a cinnamoyl group and a coumaroyl group as defined above.

According to some embodiments, condensed tannins are tannins in which a catechin unit is bound glycosidically to a gallotannin or an ellagitannin unit as defined above. In certain embodiments such condensed tannins are oligomeric and/or polymeric proanthocyanidins, or condensed proanthocyanidins. For instance, but not by the way of limitation, a condensed tannin can be represented by formula (IV):

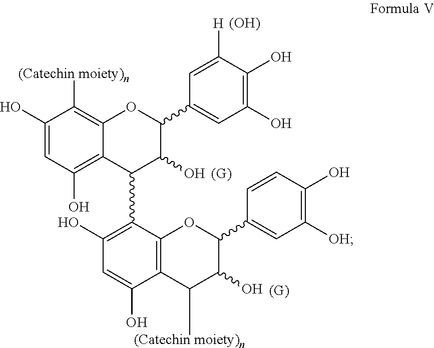

wherein each R is identical or different, and can include or consist of a galloyl moiety or any other substituent, such as but not limited to H, G, a cinnamoyl group and a coumaroyl group as defined above.

As used herein, the term “ellagic acid” refers to a form of ellagitannin of chemical formula C₁₄H₆O₈. Ellagic acid (CAS Reg. No. 476-66-4) also known as 4,4′,5,5′,6,6′-Hexahydroxydiphenic acid 2,6,2′,6′-dilactone is an organic heterotetracyclic compound resulting from the formal dimerisation of gallic acid.

The ellagic acid source can include, without limitation, natural sources such as pomegranate, eucalyptus, strawberries, grapes, blackberries, raspberries, cranberries, guava, pecans, walnuts and chestnut trees or to any extract, part, or extract of a part of the natural source.

When used herein, the term “tannic acid” refers to a form of gallotannins of chemical formula C₇₆H₅₂O₄₆ of the hydrolysable class. Tannic acid (CAS Reg. No. 1401-55-4) is a complex polyphenolic organic compound that can yield gallic acid and either glucose or quinic acid if it undergoes hydrolysis. Tannic acid is a yellowish-white to light brown substance in the form of an amorphous solid, bulky powder, glistening scales, or spongy masses. It is either odorless, or has a faint characteristic odor, and has an astringent taste. Tannic acid can be obtained by solvent extraction of nutgalls or excrescences that form on young twigs of Quercus infectoria Oliver or related species of Quercus. Tannic acid can also be obtained by solvent extraction of seed pods of Tara (Caesalpinia spinosa) or nutgalls of various sumac species, including Rhus semialata, R. coriaria, R. galabra, and R. typhia. Other examples of suitable tannic acid plant sources include, but are not limited to, Rhus chinensis, Rhus javanica, Rhus semialata, Rhus coriaria, Rhus potaninii, Rhus punjabensis var. sinica (Diels) Rehder & E. H. Wilson, Camellia sinensis, Berry, Bixa orellana, Vitis vinifera, Punica granatum, Quercus infectoria, Quercus cerris, Acacia mearnsii, Pseudotsuga menziesii, Caesalpinia spinosa, Fagus hayata Palib. ex Hayata, or Machilus thunbergii Sieb. & Zucc. Tannic acid source can also include, without limitation, other natural sources such as but not limited to gallnut, pomegranate or wood such as oak, walnut, mahogany, sumac or to any extract, part, or extract of a part of said natural source(s).

When used herein, the term “gallic acid” refers to a form of gallotannins of the chemical formula C₆H₂(OH)₃COOH of the hydrolysable class. Gallic acid (CAS Reg. No. 149-91-7) also known as 3,4,5-trihydroxybenzoic acid is a trihydroxybenzoic acid, a type of phenolic acid.

As used herein, the term “medicament” refers to any compound or composition that provides a benefit or therapeutic effect to the subject. This benefit or therapeutic effect can be achieved upon initial application and/or over time with continued use. The term “medicament” is acceptable for use in human or non-human subjects for treatment, particularly for animal use.

As used herein, the term “preventing” can also encompass the reduction of a likelihood of occurrence, or of re-occurrence of a condition.

As used herein, the term “cellular oxidative stress” refers to an imbalance between oxidants and antioxidants in favor of the oxidants, leading to a disruption of redox signaling and control and/or molecular damage. Cellular oxidative stress is defined by Helmut Seis in 1985 (“Oxidative stress”, Academic press, eBook ISBN: 9781483289113, the entirety of which is hereby incorporated herein by reference).

As used herein, the term “immune response” refers to the homeostatic mechanism that has the ability to detect and recognize foreign molecules (such as an antigen). The initial response to foreign molecule is termed “innate immunity” and is characterized by the rapid migration of natural killer cells, macrophages, neutrophils, and other leukocytes to the foreign pathogen site. These cells can either phagocytose, digest, lyse or secrete cytokines that lyse pathogens in a short period of time. The innate immune response is not antigen-specific but is generally regarded as the first line of defense against foreign pathogens until an “adaptive immune response” occurs. Both T-cells and B-cells participate in the adaptive immune response. Various mechanisms are involved in the formation of adaptive immune responses. Consideration of all possible adaptive immune response formation mechanisms is beyond the scope of this section; however, some well-characterized mechanisms are antigen B cell recognition, followed by antigen-specific activation to secrete antibodies and T cell activation by binding to antigen presenting cells.

As used herein, the term “eliciting an immune response” shall be understood to refer to the ability of a subject to raise a specific antibody response and/or a specific T-cell response to an antigen. In certain particular embodiments, the immune response is an antibody response.

As used herein, the term “increasing an immune response” refers to enhancing the immune response and/or extending the duration of the immune response. Specifically, throughout the present disclosure the term “increasing an immune response” refers to a property or process that increases the magnitude and/or effectiveness of an immunoreactivity for a given antigen. The administration of the antigen can be intentional, e.g., administration of a live vaccine strain.

As used herein, the term “infection” has the meaning generally used and understood by persons skilled in the art and includes the invasion and multiplication of a microorganism, i.e., bacterium, virus, fungi or parasite (such as an antigen), in or on a subject with or without a manifestation of a disease. An infection can occur at one or more sites in or on a subject. An infection can be unintentional, e.g., unintended ingestion, inhalation, contamination of wounds, or intentional, e.g., administration of a live vaccine strain. In particular, the term “infection” can encompass viral infections, parasitic infections (such as those linked to a fungus), and bacterial infections.

Examples of viral infections include, but are not limited to rabies virus; cytomegalovirus (CMV) pneumonia; Epstein-Barr virus; varicella-zoster virus; HSV-1 and -2 mucositis; HSV-6 encephalitis; BK-virus hemorrhagic cystitis; viral influenza; respiratory multinuclear virus (RSV); hepatitis A, B, or C.

Examples of fungal infections include, but are not limited to, aspergillosis; cough throat (caused by Candida albicans); cryptococcosis (caused by Cryptococcus); and histoplasmosis. Thus, examples of infectious fungi include Cryptococcus neoformans, Histoplasma capsulatum, Coccidioides immitis, Blastomyces dermatitidis.

Examples of infectious bacteria include: Helicobacter pylori, Borelia burgdorferi, Legionella pneumophilia, Mycobacteria sps (human tuberculosis) M tuberculosis, M avium, Mycobacterium intracellulare, M kansaii, M gordonae)), Staphylococcus aureus, Neisseria gonorrhoeae, Neisseria meningitidis, Listeria monocytogenes, Streptococcus pyogenes (Group A streptococcus), Streptococcus Streptococcus agalactiae (Group B Streptococcus), Viridans streptococci (Streptococcus (viridans group)), Streptococcus faecalis, Streptococcus bovis, Streptococcus (anaerobic sps.), Streptococcus pneumoniae, Pathogenic Campylobacter species (Campylobacter species) sp.), Enterococcus sp., Haemophilus influenzae, Bacillus anthracis, corynebacterium diphtherias, Corynebacterium sp., Erysipelothrix rhusiopathiae , Clostridium perfringens, Clostridium tetani, Enterobacter aerogenes, Klebsiella pneumoniae, Pasteurella multocida, Bacteroides sp. Bacteroides sp. (Fusobacterium nucleatum), Streptobacillus moniliformis, Treponema pallidium, Treponema pertenue, Leptospira, and Actinomyces israeli. Other infectious organisms (such as protozoa) include: Plasmodium falciparum, and Toxoplasma gondii.

As used herein, the term “allergic reaction” is a clinical response by an individual to an allergen. Symptoms of allergic reactions can affect the cutaneous (e.g., urticaria, angioedema, pruritus), respiratory (e.g., wheezing, coughing, laryngeal edema, rhinorrhea, watery/itching eyes), gastrointestinal (e.g., vomiting, abdominal pain, diarrhea), and/or cardiovascular (if a systemic reaction occurs) systems.

As used herein, the term “allergen” is an antigen that (i) elicits an IgE response in an individual; (ii) elicits an asthmatic reaction (e.g., chronic airway inflammation characterized by eosinophilia, airway hyperresponsiveness, and excess mucus production), whether or not such a reaction includes a detectable IgE response; and/or (iii) elicits an allergic reaction (e.g., sneezing, watery eyes, puritis, diarrhea, anaphylaxis), whether or not such a reaction includes a detectable IgE response.

As used herein, the term “inflammation” refers to a biological response of a subject's tissue to a noxious stimulus such as a pathogen, damaged cell, or irritant. It can be generally characterized by the secretion of inflammatory cytokines.

Inflammation is a localized reaction of live tissue due to an injury, which can be caused by various endogenous and exogenous factors. The exogenous factors include physical, chemical, and biological factors. The endogenous factors include inflammatory mediators, antigens, and antibodies. Endogenous factors often develop under the influence of an exogenous damage. An inflammatory reaction is often followed by an altered structure and penetrability of the cellular membrane. Endogenous factors, such as mediators and antigens define the nature and type of an inflammatory reaction, especially its course in the zone of injury. In the case where tissue damage is limited to the creation of mediators, an acute form of inflammation develops. If immunologic reactions are also involved in the process, through the interaction of antigens, antibodies, and autoantigens, a long-term inflammatory process will develop.

According to some embodiments, an “inflammation” can thus be associated to an inflammatory disease. Within the present context, such inflammatory diseases result from the activation, degranulation and consequent secretion of inflammatory biochemicals from mast cells. In a non-exhaustive manner, the resultant inflammatory diseases can thus include the group consisting of: allergic inflammation, arthritis (such as osteoarthritis and rheumatoid arthritis), fibromyalgia, chronic fatigue syndrome, inflammatory bowel disease, interstitial cystitis, irritable bowel syndrome, migraines, atherosclerosis, coronary inflammation, ischemia, chronic prostatitis, eczema, multiple sclerosis, psoriasis, sun burn, periodontal disease of the gums, superficial vasodilator flush syndromes, hormonally-dependent cancers, and endometriosis.

As used herein, the term “cellular oxidative stress” refers to an imbalance between oxidants and antioxidants in favor of the oxidants, leading to a disruption of redox signaling and control and/or molecular damage. Cellular oxidative stress is defined by Helmut Seis in 1985 (“Oxidative stress”, Academic press, eBook ISBN: 9781483289113, the entirety of which is hereby incorporated herein by reference). Cellular oxidative stress can be characterized through the occurrence of cellular damage, and in particular through the occurrence of DNA damage.

As used herein, the term “effective amount” refers to an amount of an ingredient which, when included in a composition, is sufficient to achieve an intended compositional or physiological effect. Thus, a “therapeutically effective amount” refers to a non-toxic, but sufficient amount of an active agent, to achieve therapeutic results in treating or preventing a condition for which the active agent is known to be effective. It is understood that various biological factors can affect the ability of a substance to perform its intended task. Therefore, an “effective amount” or a “therapeutically effective amount” can be dependent in some instances on such biological factors. Further, while the achievement of therapeutic effects can be measured by a physician or other qualified medical personnel using evaluations known in the art, it is recognized that individual variation and response to treatments can make the achievement of therapeutic effects a subjective decision. The determination of an effective amount is well within the ordinary skill in the art of pharmaceutical and nutritional sciences as well as medicine and refers to the amount of a conjugate (e.g., carnosic acid, hydroxytyrosol, tannin, ellagic acid, gallic acid) or combination necessary or sufficient to realize the desired biological effect.

As used herein, “administration”, and “administering” refer to the manner in which an active agent, or composition containing such, is presented to a subject. Administration can be accomplished by various routes well-known in the art such as oral and non-oral methods. As used herein, “oral administration” refers to a route of administration that can be achieved by swallowing, chewing, or sucking of an oral dosage form comprising the food composition or animal food product. Examples of oral dosage forms include tablets capsules, caplets, powders, granulates, beverages, jelly, kibbles, or other animal food products as mentioned in the present disclosure.

### Food Compositions and Food Products

The present disclosure provides food compositions, companion animal food products including a food composition of the disclosure, or kits for preparing companion animal food products of the disclosure, including a combination of:
(i) a carnosic acid source;
(ii) a hydroxytyrosol source; and
(iii) a tannin source.

In certain embodiments, the tannin source can include a hydrolysable tannin source, such as a gallotannin source, an ellagitannin source, or a combination thereof.

In certain embodiments, the tannin source can include a tannic acid source, a gallic acid source, or a combination thereof. In inn certain particular embodiments, the tannin source can be a tannic acid source. In certain other particular embodiments, the tannin source can be a gallic acid source. In certain other particular embodiments, the tannin source can be a combination of a tannic acid source and a gallic acid source; in particular with a tannic acid:gallic acid ratio ranging from about 1:5 to about 1:50. In certain particular embodiment the tannic acid:gallic acid ratio can be from about 1:10 to about 1:40. In certain more particular embodiments, the tannic acid:gallic acid ratio can be from about 1:15 to about 1:30.

In certain embodiments, the ellagitannin source can include an ellagic acid source. The food composition according to the present disclosure is prepared according to the techniques which are well known to a person skilled in the art.

In certain embodiments, the food composition, companion animal food product including the food composition, or kit for preparing the companion animal food product includes non-naturally occurring carnosic acid, hydroxytyrosol, tannin such as tannic acid, ellagic acid and/or a gallic acid. In certain embodiments, the carnosic acid sources, the hydroxytyrosol sources, the tannin sources such as the tannic acid sources, the ellagic acid sources and/or the gallic acid sources can be selected from natural sources; such as those derived from plant or vegetable sources.

The recited carnosic acid source, hydroxytyrosol source, tannin source such as tannic acid source, ellagic acid source and/or gallic acid source can refer to the same source or to distinct sources.

In certain embodiments, the recited carnosic acid source, hydroxytyrosol source, tannin source such as tannic acid source, ellagic acid source and/or gallic acid source can refer to distinct sources; in particular to distinct natural sources.

In certain embodiments, the carnosic acid source, the hydroxytyrosol source and the tannin source such as tannic acid source, ellagic acid source and/or gallic acid source can be present in an amount of less than about 40 ppm; in particular in an amount ranging from about 3 ppm to less than about 40 ppm.

In certain embodiments, the tannin source can be a hydrolysable tannin source. In certain particular embodiments tannin source can be a gallotannin source and/or an ellagitannin source.

In certain embodiments, the tannin source can be a tannic acid source, a gallic acid source, an ellagic acid source, or a combination thereof.

In certain embodiments, the recited food composition, companion animal food product including the food composition or kit for preparing the companion animal food product include minimal amounts of tocopherols or are even devoid of tocopherols.

According to some embodiments, the recited food composition, companion animal food product including the food composition or kit for preparing the companion animal food product can include tocopherols, in amounts which are less than about 1 ppm.

According to other embodiments, a companion animal food product including a food composition according to the disclosure, can be a coated animal food product, such as e.g., a coated dry animal food product, wherein the coated animal food product includes a core and a coating at least partially covering the core.

In certain other embodiments, the food composition of the disclosure can be in the core of the companion animal food product.

In certain other embodiments, the food composition of the disclosure can be in the coating of the companion animal food product.

According to some embodiments, the hydroxytyrosol source and the tannin source can be in the core and the carnosic acid source can be in the coating.

In some embodiments, the carnosic acid source being in the coating can be present in an amount of less than about 40 ppm, in particular in an amount ranging from about 3 ppm to less than about 40 ppm (with respect to the total weight of the food composition or product).

In some embodiments, the hydroxytyrosol source and the at least one of a tannin source, an ellagic acid source or a gallic acid source being in the core can be present in an amount of less than about 40 ppm, in particular in an amount ranging from about 3 ppm to less than about 40 ppm.

According to some other embodiments, the carnosic acid source and the hydroxytyrosol source can be in the core and the tannin sourcecan be in the coating.

In some embodiments, the tannin source being in the coating can be present in an amount of less than about 40 ppm, in particular in an amount ranging from about 3 ppm to less than about 40 ppm.

In some embodiments, the carnosic acid source and the hydroxytyrosol source being in the core can be present in an amount of less than about 40 ppm, in particular in an amount ranging from about 3 ppm to less than about 40 ppm.

According to some other embodiments, the tannin sourceand the carnosic acid source can be in the core and the hydroxytyrosol source can be in the coating.

In some embodiments, the hydroxytyrosol source being in the coating can be present in an amount of less than about 40 ppm, in particular in an amount ranging from about 3 ppm to less than about 40 ppm.

In some embodiments, the tannin source and the carnosic acid source being in the core can be present in an amount of less than about 40 ppm, in particular in an amount ranging from about 3 ppm to less than about 40 ppm.

In certain embodiments, the food composition, companion animal food product or kit according to the disclosure does not include tocopherol.

In certain particular embodiments, a food composition or kit of the present disclosure can be a combination of a carnosic acid source, a hydroxytyrosol source and a tannin source such as tannic acid source, ellagic acid source and/or gallic acid source. In other terms, a carnosic acid source, a hydroxytyrosol source and a tannin source such as tannic acid source, ellagic acid source and/or gallic acid source; can be the only antioxidants of the combination.

Advantageously, a food composition of the disclosure can be in a powder form or in a liquid form. Thus, in certain particular embodiments a natural food composition of the present disclosure, further includes an appropriate carrier. The skilled person is able to determine appropriate carriers depending on the use, in particular depending on the form of the combination, i.e., liquid or powder, and/or on the hydrophilic or hydrophobic form of the combination.

The present disclosure further provides a companion animal food product including a food composition according to the disclosure.

In particular, the food composition of the present disclosure can either be a companion animal food product as defined above, or a food composition which can in turn be incorporated into a companion animal food product.

In certain embodiments, the companion animal food product can include proteins, carbohydrates and/or crude fats. Animal food products can also contain supplementary substances or additives, for example, minerals, vitamins and condiments (See Merriam-Webster's Collegiate Dictionary, 10th Edition, 1993, the content being incorporated by reference). Such companion animal food products can be nutritionally complete or not. In certain embodiments, a companion animal food product according to the present disclosure can be a nutritionally complete food product.

In certain embodiments, a companion animal food product includes at least a combination of (i) a carnosic acid source, (ii) a hydroxytyrosol source, and (iii) a tannin source. The tannin source can be a hydrolysable tannin source, such as a gallotannin source, an ellagitannin source or a combination thereof. In certain embodiments, the tannin source can be a hydrolysable tannin selected from a tannic acid source, a gallic acid source, an ellagic acid source, or a combination thereof In certain particular embodiments, the tannin source can be a tannic acid source. In certain other particular embodiments, the tannin source can be a gallic acid source. In certain otherparticular embodiments, the tannin source can be a combination of a tannic acid source and a gallic acid source; in particular with a tannic acid:gallic acid ratio about 1:10 to about 1:40. In certain embodiments, the tannic acid:gallic acid ratio can be from about 1:15 to about 1:30. In certain embodiments, it also can include less than about 1 ppm of tocopherol.

In certain embodiments, a companion animal food product includes at least a combination of (i) a carnosic acid source, (ii) a hydroxytyrosol source, and (iii) a tannin source. The tannin source can be a hydrolysable tannin source, such as a gallotannin source, an ellagitannin source, or a combination thereof In certain embodiments, the tannin source can be a hydrolysable tannin selected from a tannic acid source, a gallic acid source, an ellagic acid source, or a combination thereof. In certain particular embodiments, the tannin source can be a tannic acid source. In certain other particular embodiments, the tannin source can be a gallic acid source. In certain otherparticular embodiments, the tannin source can be a combination of a tannic acid source and a gallic acid source; in particular with a tannic acid:gallic acid ratio ranging from about 1:5 to about 1:50. In certain particular embodiments, the tannic acid:gallic acid ratio can be from about 1:10 to about 1:40. In certain other embodiments, the tannic acid:gallic acid ratio can be from about 1:15 to about 1:30. In certain embodiments, it can not comprise tocopherol.

In certain other embodiments, a companion animal food product includes at least a combination of (i) a carnosic acid source in an amount ranging from at least about 3 ppm to less than about 40 ppm, (ii) a hydroxytyrosol source in an amount ranging from at least about 3 ppm to less than about 40 ppm, and (iii) a tannin source in an amount ranging from at least about 3 ppm to less than about 40 ppm; and it includes less than about 1 ppm of tocopherol.

In certain embodiments, a companion animal food product includes at least a combination of (i) a carnosic acid source, (ii) a hydroxytyrosol source, and (iii) a tannin source. The tannin source can be a hydrolysable tannin source, such as a gallotannin source, an ellagitannin source, or a combination thereof In certain embodiments, the tannin source can be a hydrolysable tannin selected from a tannic acid source, a gallic acid source, an ellagic acid source, or a combination thereof. In some embodiments, it can not include tocopherol.

In certain particular embodiments, a companion animal food product includes at least a combination of (i) a carnosic acid source in an amount ranging from at least about 3 ppm to less than about 40 ppm, (ii) a hydroxytyrosol source in an amount ranging from at least about 3 ppm to less than about 40 ppm, and (iii) a tannin source, in an amount ranging from at least about 3 ppm to less than about 40 ppm; and it can not include tocopherol.

In certain embodiments, the said sources of the animal food product can be natural sources. In certain nonlimiting embodiments, the carnosic acid source can be a rosemary extract, the hydroxytyrosol source can be an olive extract, and the tannin source can be a gallnut and/or pomegranate extract.

In certain embodiments, the present disclosure relates to a companion animal food product including at least a combination of (i) a rosemary extract, (ii) an olive exctract, and (iii) a gallnut extract.

In certain other embodiments, a companion animal food product of the disclosure can be a dry animal food product. In certain other embodiments the dry animal food product can be a kibble. For example, and without limitation, kibbles include particulates; pellets; pieces of pet food, dehydrated meat, meat analog, vegetables, and combinations thereof; and pet snacks, such as meat or vegetable jerky, rawhide, and biscuits. The dry animal food product can be manufactured by mixing together ingredients and kneading in order to make consistent dough that can be cooked. In general, it can be the final product of a process including an extrusion step followed by a drying step.

In certain other embodiments, a companion animal food product according to the disclosure is palatable for animals such as feline or canines, particularly cats or dogs.

According to some embodiments, a food composition of the disclosure can be in any form selected from a functional food, a dietary, a food additive, a food preservative, a supplement, a drug, a foodstuff, or a nutritionally complete food composition.

Non-limiting examples of components that can be incorporated in the food compositions of the present disclosure are further provided below.

### Carnosic Acid

In certain embodiments, the food compositions of the present disclosure can include carnosic acid. In certain nonlimiting embodiments, a carnosic acid source can include or can consist of rosemary (Rosmarinus officinalis) or common sage (Salvia officinalis), or a combination thereof.

In another embodiments, the carnosic acid source can include or can consist of rosemary extract.

In certain embodiments, the carnosic acid source can be present in the preservative food composition in an amount of less than about 40 ppm, relative to the total weight of the preservative food composition.

For instance, the carnosic acid source can be present in the food composition in an amount of less than about 40, 35, 30, 25, 20, 15, 10 or even about 5 ppm relative to the total weight of the preservative food composition.

For instance, the carnosic acid source can be present in the preservative food composition in an amount of less than about 40 ppm and more than about 0.1 ppm relative to the total weight of the preservative food composition.

For instance, the carnosic acid source can be present in the preservative food composition in an amount of less than about 40 ppm and more than about 3 ppm relative to the total weight of the preservative food composition.

In certain embodiments, the carnosic acid source can be present in the companion animal food product in an amount of less than about 40 ppm, relative to the total weight of the companion animal food product.

For instance, the carnosic acid source can be present in the companion animal food product in an amount of less than about 40, 35, 30, 25, 20, 15, 10 or even 5 ppm relative to the total weight of the companion animal food product.

For instance, the carnosic acid source can be present in the companion animal food product in an amount of less than about 40 ppm and more than about 0.1 ppm.

For instance, the carnosic acid source can be present in the companion animal food product in an amount of less than about 40 ppm and more than about 3 ppm.

### Hydroxytyrosol

In certain embodiments, the food compositions of the present disclosure can include hydroxytyrosol. In certain nonlimiting embodiments, the hydroxytyrosol source can include or can consist of olive or an extract thereof

In certain other embodiments, the hydroxytyrosol source can include or consist of an olive extract.

In certain embodiments, the hydroxytyrosol source of the preservative food composition can be present in an amount of less than about 40 ppm relative to the total weight of the preservative food composition.

In certain embodiments, the hydroxytyrosol source of the preservative food composition can be present in an amount of less than about 40 ppm and more than about 0.1 ppm.

For instance, the hydroxytyrosol source can be present in the food composition in an amount of less than about 40, 35, 30, 25, 20, 15, 10 or even 5 ppm relative to the total weight of the preservative food composition.

For instance, the hydroxytyrosol source can be present in the preservative food composition in an amount of less than about 40 ppm and more than about 0.1 ppm relative to the total weight of the preservative food composition.

For instance, the hydroxytyrosol source can be present in the preservative food composition in an amount of less than about 40 ppm and more than about 3 ppm relative to the total weight of the preservative food composition.

In certain embodiments, the hydroxytyrosol source of the companion animal food product can be present in an amount of less than about 40 ppm and more than about 0.1 ppm relative to the total weight of the companion animal food product.

For instance, the hydroxytyrosol source can be present in the companion animal food product in an amount of less than about 40, 35, 30, 25, 20, 15, 10 or even 5 ppm relative to the total weight of the companion animal food product.

For instance, the hydroxytyrosol source can be present in the companion animal food product in an amount of less than about 40 ppm and more than about 0.1 ppm relative to the total weight of the companion animal food product.

For instance, the hydroxytyrosol source can be present in the preservative food composition in an amount of less than about 40 ppm and more than about 3 ppm relative to the total weight of the animal food product.

### Tannin

In certain embodiments, the food compositions of the present disclosure can include one or more tannins. In certain nonlimiting embodiments, the tannin can include or can consist of hydrolysable tannin or condensed tannin or a combination thereof.

In certain embodiments, the tannins can include gallotannins, ellagitannins, complex tannins, and condensed tannins or a combination thereof.

In certain embodiments, the hydrolysable tannin can include gallotannins and ellagitannins, or a combination thereof.

In certain embodiments, the tannin source can include a gallic acid source, a tannic acid source, or a combination thereof.

In certain embodiments, the tannin source can include a tannic acid source.

In certain embodiments, the tannin source can include a gallic acid source.

In certain embodiments, the tannin source can include a combination of a tannic acid source and a gallic acid source. In such an embodiments, the tannic acid:gallic acid ratio ranging from about 1:5 to about 1:50. In one embodiment the tannic acid:gallic acid ratio can be from about 1:10 to about 1:40. In one embodiments, the tannic acid:gallic acid ratio can be from about 1:15 to about 1:30.

In certain embodiments, tannins used in the food products of the present disclosure can be provided from two or more different sources. In an exemplary embodiment of the present disclosure, tannic acid from Quercus spp can be combined with gallic acid from Rhus spp, the tannic acid to gallic acid ratio ranging from 1:5 to 1:50. In certain embodiments, tannic acid used in the composition of the present disclosure, more specifically the food composition according to the disclosure, can undergo further hydrolysis during food processing, like extrusion, yielding to hydrolysates products, including gallic acid, thus impacting the ratio tannic acid to gallic acid in the final product. The person skilled in the art would anticipate this hydrolyzation in order to incorporate th right amount of tannic acid, and eventually gallic acid, to achieve the final ratio ranging from about 1:5 to about 1:50; from about 1:10 to about 1:40; or from about 1:15 to about 1:30. In an embodiments, there can be no need to add gallic acid as the hydrolyzation of the tannic acid can be sufficient to achieve the final ratio ranging from about 1:5 to about 1:50.

In certain embodiments, the ellagitannin source can include an ellagic acid source.

In certain embodiments, the tannic acid source can include gallnut extract.

In certain embodiments, the ellagic acid source can include pomegranate extract.

The tannin source can include natural source such as fruit and plants, such as gallnut, strawberries, grapes, blackberries, raspberries, cranberries, pomegranate, guava, pecans, walnuts, chestnut or to any extract, part, or extract of a part of the natural source.

In certain embodiments, the tannin source of the preservative food composition can be present in an amount of less than about 40 ppm and more than about 0.1 ppm.

For instance, the tannin source can be present in the food composition in an amount of less than about 40, 35, 30, 25, 20, 15, 10 or even 5 ppm relative to the total weight of the food composition.

For instance, the combined amounts of tannic acid source, ellagic acid source and/or gallic acid source can be present in the food composition in an amount of less than about 40, 35, 30, 25, 20, 15, 10 or even 5 ppm relative to the total weight of the food composition.

For instance, the tannic acid source, ellagic acid source and/or gallic acid source can be present in the food composition in an amount of less than about 40 ppm and more than about 0.1 ppm relative to the total weight of the food composition.

For instance, the tannic acid source, ellagic acid source and/or gallic acid source can be present in the food composition in an amount of less than about 40 ppm and more than about 3 ppm relative to the total weight of the food composition.

In certain embodiments, the tannic acid source, ellagic acid source and/or gallic acid source can be present in the companion animal food product in an amount of less than about 40, 35, 30, 25, 20, 15, 10 or even 5 ppm relative to the total weight of the companion animal food product.

For instance, the tannic acid source, ellagic acid source and/or gallic acid source can be present in the companion animal food product in an amount of less than about 40 ppm and more than about 0.1 ppm relative to the total weight of the companion animal food product.

For instance, the tannic acid source, ellagic acid source and/or gallic acid source can be present in the companion animal food product in an amount of less than about 40 ppm and more than about 3 ppm relative to the total weight of the companion animal food product.

### Method of Manufacturing

In certain aspects, a method for manufacturing companion animal food products is provided. In certain embodiments, one or more dry ingredients can be mixed with one or more wet ingredients to form an emulsion or dough. In certain embodiments, one or more dry ingredients can be mixed with one or more dry ingredients to form an emulsion or dough.

In certain non-limiting embodiments, one or more wet ingredients can be mixed with one or more wet ingredients to form an emulsion or dough.

In certain non-limiting embodiments, one or more wet ingredients can be mixed with one or more dry ingredients to form an emulsion or dough.

The emulsion or dough can be heated under pressure to a predetermined temperature and gradually cooled. Alternatively, an emulsion can be formed which can be comminuted and heated to a predetermined temperature, and subsequently introduced into a processing zone. In the processing zone, the emulsion can be subjected to a predetermined pressure and discharged. For producing a chunk-like product, alternatively, a slurry can be introduced to a scraped heat exchanger at a predetermined pressure and heated to produce a heat-treated product having a certain temperature. In certain non-limiting embodiments, one or more dry ingredients can be mixed with one or more wet ingredients, for example, water, to form a dough. The dough can be cooked during extrusion under conditions of elevated temperature, pressure, or combination thereof. The extruder can be provided with a die having a particular shape and the extrudate can be segmented into particles or pieces as the product is extruded.

According to certain embodiments, the disclosure also relates to a method for manufacturing a companion animal food product including the step of mixing (i) a carnosic acid source, (ii) a hydroxytyrosol source, and (iii) a tannin source. The tannin source can be a hydrolysable tannin source, such as a gallotannin source, an ellagitannin source, or a combination thereof In certain embodiments, the tannin source can be a hydrolysable tannin selected from a tannic acid source, a gallic acid source, an ellagic acid source, or a combination thereof. In certain particular embodiments, the tannin source can be a tannic acid source. In certain other particular embodiments, the tannin source can be a gallic acid source. In certain other particular embodiments, the tannin source can be a combination of a tannic acid source and a gallic acid source; in particular with a tannic acid:gallic acid ratio ranging from about 1:5 to about 1:50. In certain embodiments, the tannic acid:gallic acid ratio can be from about 1:10 to about 1:40. In one embodiments, the tannic acid:gallic acid ratio can be from about 1:15 to about 1:30.

The companion animal food product which is manufactured can be a dry food product or a wet food product. In certain embodiments, the companion animal food product can be a dry food product.

In particular, in certain embodiments the method for manufacturing an animal food product includes the steps of:
a) mixing (i) a carnosic acid source, (ii) a hydroxytyrosol source, and (iii) a tannin source, thereby providing a mixture; and
b) heating the mixture.

In certain particular embodiments, the method for manufacturing an animal food product includes the step of mixing (i) a carnosic acid source in an amount of less than about 40 ppm, (ii) a hydroxytyrosol source in an amount less than about 40 ppm, and (iii) a tannin source in an amount less than about 40 ppm.

In certain particular embodiments, the method for manufacturing a companion animal food product includes the steps of:
a) mixing (i) a carnosic acid source in an amount of less than about 40 ppm, (ii) a hydroxytyrosol source in an amount less than about 40 ppm, and (iii) a tannin source in an amount less than about 40 ppm, thereby providing a mixture; and
b) heating the mixture.

The step of mixing is not limited to any particular type of mixing. According to exemplary embodiments, the step of mixing includes a step of:
a1) providing an extrudate including at least two sources selected from (i) a carnosic acid source, (ii) a hydroxytyrosol source, and (iii) a tannin source;
a2) coating said extrudate with at least a third source, which is different from the two sources recited at step a1), and which can be selected from i) a carnosic acid source, (ii) a hydroxytyrosol source, and (iii) a tannin source.

Advantageously, a method of manufacturing a companion animal food product includes the steps of a1) providing an extrudate of a combination of (i) a hydroxytyrosol source and of (ii) a tannin source; and a2) coating said extrudate with a carnosic acid source.

According to certain particular embodiments, a method of manufacturing a companion animal food product includes the steps of:

a1) providing an extrudate of a combination of (i) a hydroxytyrosol source in an amount of less than about 40 ppm relative to the total weight of the extrudate and of (ii) a tannin source in an amount of less than about 40 ppm relative to the total weight of the extrudate;
a2) coating said extrudate with a carnosic acid source, thereby providing a mixture;
b) heating the mixture.

A person of ordinary skill in the art will appreciate a wide variety of methods of manufacturing animal food products are suitable for use with the present disclosure.

### Use of the Food Composition as a Preservative Agent

According to another aspect, the present disclosure relates to the use of a food composition or kit as described herein as a preservative for a companion animal food product.

According to certain embodiments, the present disclosure describes the use of an antioxidant combination of (i) a carnosic acid source, (ii) a hydroxytyrosol source, and (iii) a tannin source, such as a tannic acid source, an ellagic acid source and/or a gallic acid source; as a preservative for a companion animal food product.

Otherwise said, the food composition of the present disclosure can be used as a preservative agent for a companion animal food product, or the food composition can be used as an antioxidant for a companion animal food product.

As mentioned, the food composition according to the disclosure can be incorporated to any animal food product, in particular to any companion animal food product containing fat.

In some embodiments, the food composition can be used for the preservation of meat products, like for instance meat, poultry products, fish, crustaceans, vegetables, pre-cooked meals, ready-to-serve meals, dairy products, jams, jellies, beverages and kibbles.

In some embodiments, the food composition can be used for the preservation of companion animal food products, in particular for wet food products and dry food products. In certain particular embodiments, the food composition of the present disclosure can be used for preservation of dry food products.

The food composition can be added to a final stage of the companion animal food product to be preserved or it can be added to an initial stage which would have the advantage of treating the companion animal food product, whereby the food composition can be added as dry product to the companion animal food product to be preserved, or in the form of a solution or dispersion.

In particular, the present disclosure describes the use of a combination of (i) a carnosic acid source in an amount of less than about 40 ppm, (ii) a hydroxytyrosol source in an amount of less than about 40 ppm, and (iii) a tannin source in an amount of less than about 40 ppm; as a preservative for a companion animal food product.

This combination thus can contain (i) carnosic acid, (ii) hydroxytyrosol, and (iii) tannic acid, ellagic acid, gallic acid, or a combination thereof. In certain particular embodiments, this combination can contain (i) carnosic acid, (ii) hydroxytrosol, and (iii) tannic acid. In certain other particular embodiments, this combination can contain (i) carnosic acid, (ii) hydroxytrosol, and (iii) gallic acid. In certain other particular embodiments, this combination can contain (i) carnosic acid, (ii) hydroxytrosol, and (iii) a combination of tannic acid gallic acid; in particular with a tannic acid:gallic acid ratio ranging from about 1:5 to about 1:50. In one embodiment the tannic acid:gallic acid ratio can be from about 1:10 to about 1:40. In one embodiments, the tannic acid:gallic acid ratio can be from about 1:15 to about 1:30.

According to certain embodiments, the present disclosure provides a method for maintaining the PV (Peroxide Value) of an animal food product, said method including the step of bringing into contact the said food product with a combination of (i) a carnosic acid source; (ii) a hydroxytyrosol source; and (iii) a tannin source.

In particular, the present disclosure provides a method for maintaining the PV of an animal food product below 10 mEq/kg fat during at least 12 months, said method including the incorporation in the said food product of a combination of (i) a carnosic acid source in an amount of less than about 40 ppm, (ii) a hydroxytyrosol source in an amount of less than about 40 ppm, and (iii) a tannin source in an amount of less than about 40 ppm.

In certain particular embodiments, the method can be suitable for maintaining the PV value of the companion animal food product below about 10 mEq/kg fat during at least about 12 months under paper bag conditions.

In certain particular embodiments, the method can be suitable for maintaining the PV value of the companion animal food product below about 10 mEq/kg fat during at least about 18 months under atmosphere-controlled conditions.

According to certain particular embodiments, the present disclosure provides a method for maintaining the hexanal value of a companion animal food product, said method including the step of bringing into contact the said food product with a combination of (i) a carnosic acid source; (ii) a hydroxytyrosol source; and (iii) a tannin source.

In particular, in certain embodiments, the present disclosure provides a method for maintaining the hexanal value of a companion animal food product below about 15 ppm during at least about 12 months, said method including the incorporation in the said food product of a combination of (i) a carnosic acid source in an amount of less than about 40 ppm, (ii) a hydroxytyrosol source in an amount of less than about 40 ppm, and (iii) a tannin source in an amount of less than about 40 ppm.

In certain particular embodiments, the method of the present disclosure can be suitable for maintaining the hexanal value of the animal food product below about 15 ppm during at least about 12 months under paper bag conditions.

In certain particular embodiments, the method can be suitable for maintaining the hexanal value of the animal food product below aboutl5 ppm during at least about 18 months under atmosphere-controlled conditions.

### Therapeutic Methods

According to another aspect, the present disclosure relates to the food composition, or companion animal food product or kit as described herein for use as a medicament.

In some embodiments, the present disclosure provides a food composition, product or kit thereof including at least a combination of an effective amount of:
(i) a carnosic acid source;
(ii) a hydroxytyrosol source; and
(iii) a tannin source;
for use as medicament.

In some embodiments, the present disclosure provides a food composition, product or kit thereof including at least a combination of:
(i) a carnosic acid source;
(ii) a hydroxytyrosol source; and
(iii) at least one of a hydrolysable tannin source;
for use as medicament.

In some embodiments, the present disclosure provides a food composition, product or kit thereof including at least a combination of:
(i) a carnosic acid source;
(ii) a hydroxytyrosol source; and
(iii) at least one of a tannic acid source, a gallic acid source and an ellagic acid source;
for use as medicament.

In some embodiments, the food composition, product or kit according to the present disclosure can be used in a method for treating or preventing or reducing the likelihood of occurrence of cellular oxidative stress.

In some embodiments, the food composition, product or kit according to the present disclosure can be used in a method for treating or preventing or reducing the likelihood of occurrence of inflammation or an inflammatory disorder.

In some embodiments, the food composition, product or kit according to the present disclosure can be used in a method for eliciting or increasing an immune response of a companion animal, or for preventing or reducing the likelihood of occurrence of an infection and/or an allergic reaction of a companion animal, such as eliciting or increasing an immune response toward a viral or bacterial or parasitic infection.

In certain embodiments, the present disclosure provides a novel food composition, which can be used to prevent or reduce the likelihood of occurrence of an infection and/or allergic reaction. In certain embodiments the food composition of the present disclosure can be used to resist or attenuate the negative effects of a viral, bacterial, or parasitic infection of a companion animal.

As previously mentioned, even healthy animals regardless of their age can have a weakened immune system, resulting in a greater sensitivity allergen and higher susceptibility to infections, such as viral, bacterial or parasitic infections. In certain embodiments, administration of the food composition of the present disclosure can lessen the impact of an infection and/or an allergic reaction on the health of the companion animal.

In certain embodiments, use of the food composition or companion animal food product or kit of the disclosure can oppose, attenuate, or reverse age-related effects on the immune response toward a viral or bacterial or parasitic infection in an animal. In certain embodiments, the animal is an older animal.

The food composition of the disclosure can elicit an immune response against viral or bacterial or parasitic infection and/or allergic reactions when administered to a companion animal.

In some embodiments, the present disclosure provides a method for preventing or reducing the likelihood of occurrence of an infection and/or an allergic reaction in a companion animal, the method including at least the step of providing an effective amount of a food composition or companion animal food product or kit according to the present disclosure to be administered to the companion animal

In some embodiments, the present disclosure provides a therapeutic method for preventing or reducing the likelihood of occurrence of an infection and/or an allergic reaction in a companion animal, the method including: providing a food composition or companion animal food product or kit according to the present disclosure; and administering to the companion animal an effective amount of the food composition or companion animal food product or kit.

In some embodiments, the present disclosure provides a method for treating or preventing or reducing the likelihood of occurrence of a cellular oxidative stress, the method including at least the step of providing an effective amount of a food composition or companion animal food product or kit according to the present disclosure to be administered to the companion animal.

In some embodiments, the present disclosure provides a therapeutic method for treating or preventing or reducing the likelihood of occurrence of a cellular oxidative stress, the method including: providing a food composition or companion animal food product or kit according to the present disclosure; and administering to the companion animal an effective amount of the food composition or companion animal food product or kit.

In some embodiments, the present disclosure provides a method for preventing or reducing the likelihood of occurrence of an infection and/or an allergic reaction in a companion animal, the method including at least the step of providing an effective amount of a food composition or companion animal food product or kit according to the present disclosure to be administered to the companion animal.

In some embodiments, the present disclosure provides a therapeutic method for preventing or reducing the likelihood of occurrence of an infection and/or an allergic reaction in a companion animal, the method including; providing a food composition or companion animal food product or kit according to the present disclosure; and administering to the companion animal an effective amount of the food composition or companion animal food product or kit.

In some embodiments, the present disclosure provides a method for treating or preventing or reducing the likelihood of occurrence of inflammation or an inflammatory disorder in a companion animal, the method including at least the step of providing an effective amount of a food composition or companion animal food product or kit according to the present disclosure to be administered to the companion animal.

In some embodiments, the present disclosure provides a method for treating or preventing or reducing the likelihood of occurrence of inflammation or an inflammatory disorder, the method including: providing a food composition or companion animal food product or kit according to the present disclosure; and administering to the companion animal an effective amount of the food composition or companion animal food product or kit.

In some embodiments, the present disclosure provides a method for eliciting or increasing in a companion animal an immune response, the method including at least the step of providing an effective amount of a food composition or companion animal food product or kit according to the present disclosure to be administered to the companion animal.

In some embodiments, the present disclosure provides a method for eliciting or increasing in a companion animal an immune response, the method including: providing a food composition or companion animal food product or kit according to the present disclosure; and administering to the companion animal an effective amount of the food composition or companion animal food product or kit.

In some embodiments, the present disclosure provides a therapeutic method as defined above, such as for preventing or reducing the likelihood of occurrence of an infection and/or an allergic reaction in a companion animal, the method including:
a) providing a food composition or companion animal food product or kit according to the present disclosure; and
b) administering to the companion animal an effective amount of the food composition or companion animal food product or kit.

In some embodiments, a food composition or companion animal food product or kit as disclosed herein can be provided to an animal to be treated during the time period of treatment. According to these embodiments, the said food composition is provided to the companion animal on a daily basis during the time period of treatment.

In certain embodiments, the food composition of the present disclosure can be formulated to provide an effective amount of the active agents in accordance with a particular dosage regimen. The food composition herein can provide each of the active agents according to a desired daily dose.

In another aspect, the food composition of the present disclosure can be administered to an animal so as to deliver a desired amount of active agent on a per body weight basis. Administration can be configured based on the species of companion animal, as well as other factors such as sex, age, medical condition, and the like.

In certain particular embodiments, the food composition of the present disclosure can be formulated to provide to the animal a daily dose of an effective amount of the one or more active agents based on weight of said animal (mg/kg bw). In certain embodiments, an effective amount of the food composition can be formulated to include i) from about 0.01 to about 10 mg/kg bw, from about 0.01 to about 1 mg/kg bw or from about 0.04 to about 0.6 mg/kg bw carnosic acid source, ii) from about 0.01 to about 10 mg/kg bw, from about 0.01 to about 1 mg/kg bw or from about 0.04 to about 0.6 mg/kg bw hydroxytyrosol source and iii) from about 0.01 to about 10 mg/kg bw, from about 0.01 to about 1 mg/kg bw or from about 0.04 to about 0.6 mg/kg bw tannin source, an ellagic acid source or a gallic acid source.

In certain particular embodiments, an effective amount of the food composition can be formulated to include i) from about 0.01 to about 10 mg/kg bw, from about 0.01 to about 1 mg/kg bw or from about 0.04 to about 0.6 mg/kg bw carnosic acid source, ii) from about 0.01 to about 10 mg/kg bw, from about 0.01 to about 1 mg/kg bw or from about 0.04 to about 0.6 mg/kg bw hydroxytyrosol source and iii) from about 0.01 to about 10mg/kg bw, from about 0.01 to about 1 mg/kg bw or from about 0.04 to about 0.6 mg/kg bw tannic acid source, gallic acid source and/or ellagic acid source.

It is further contemplated that the formulations and methods discussed herein can be employed in conjunction with other treatments.

It shall be understood that, in the daily practice of feeding companion animals, the animal owner cannot proceed according to a systemic way of treating the animal with a food composition always on daily basis. However, the beneficial effects of eliciting or increasing an immune response is fully provided when the animal is treated with the food composition described herein every other day.

The time period for eliciting or increasing an immune response, or for preventing or reducing the likelihood of occurrence of an infection and/or an allergic reaction with a food composition as described herein can range from several days to several weeks.

According to certain other embodiments, the food composition can be provided to the companion animals for an exended period of time, such as for a period of time of about 12 weeks or more; such as of about 24 weeks of more, or such as about 30 weeks or more, either (i) according to a feeding schedule including providing to the companion animal exclusively the food composition described herein or (ii) according to a schedule alternating the food composition described herein and another food composition.

In some embodiments, the present disclosure provides using (i) a carnosic acid source; (ii) a hydroxytyrosol source; and (iii) a tannin source, such as a tannic acid source, an ellagic acid source and/or a gallic acid source; for the preparation of a medicament, in particular directed toward any one of the therapeutic conditions reported herein.

In a further aspect of the disclosure, the food composition for its use as a medicament can be in the form of a functional food, a dietary, a food additive, a food preservative, a supplement, a drug, a foodstuff, or a nutritionally complete food composition.

The aspects of the present disclosure are illustrated further by the following exemplary embodiments. These examples should not be considered as limitations of the disclosure but are merely in place to instruct those skilled in the art in practicing the presently disclosed subject matter. It will be apparent to those of ordinary skill in the art that numerous modifications in form, usage and details of implementation can be made without the exercise of inventive faculty, and without departing from the principles and concepts of the disclosure. Accordingly, it is not intended that the disclosure be limited, except as by the claims set forth below.

### EXAMPLES

The presently disclosed subject matter will be better understood by reference to the following Examples, which are provided as exemplary of the disclosure, and not by way of limitation. The materials and methods used in the examples are summarized below.

Abbreviations:
ATCO: Atmosphere controlled
BHA: Butylated Hydroxy Anisole
NS: Non significative
PG: propyl gallate
PV: Peroxide Value
RMs: Raw Materials
VHS: Very highly significative

### Example 1

1.1 Material & Methods

Peroxide Value and Hexanal level

Food products as obtained were analyzed so as to determine the Peroxide Value (PV) and the Hexanal level (Hexanal). PV was determined according to the method for the iodometric determination of the peroxide value of fatty substances of animal and vegetable origin by visual detection at the end of the determination: NF EN ISO 3960 (Version of April 2017) or NF EN ISO 27107 (version of June 2010).

The Hexanal level was determined according to the AOCS method Cg 4-94 (AOCS. 1997) or according to the method described in the literature (Azarbad, Determination of hexanal—an indicator of lipid oxidation by HS-GC-FID in food matrices, 2014).

Food products stored at ambient condition were analyzed the first day of the study (T0) and at 12 months after (M12) and 18 months.

Food products stored in the accelerated storage condition were analyzed the first day of the study (T0) and at the end of the study (120 days after-D120).

Commercial Formula Used in the Food Products

For cats, the food products were based on the commercial formula ROYAL CANIN® Fit 32 (F32).

For dogs, the food products were based on the commercial formula ROYAL CANIN® Medium adult (M25).

Antioxidant Combinations

Three antioxidant combinations were provided and tested in throughout the example:
Synthetic antioxidants reference (SA) using BHA, PG and citric acid;
Natural antioxidants reference (NA1G) using mixed tocopherols and rosemary extract;
New natural antioxidants combination (NA2G) using olive extract, gallnut extract and rosemary extract.

Food Products

The preparation of an animal food product is well known by the skilled person.

For cats, the food products tested were produced as follows:
F32 SA (positive control): The commercial formula F32 was mixed with 75 ppm of BHA before extrusion, then 50 ppm of BHA +17 ppm of PG +17 ppm of citric acid were applied through a fat coating.
F32 NA1G (positive control): The commercial formula F32 was mixed with 120 ppm of gamma and delta tocopherols from mixed tocopherols before extrusion, then 7 ppm of carnosic acid from rosemary extract was applied through a fat coating.
F32 NA2G: The commercial formula F32 was mixed with 22.5 ppm of gallotannins from gallnut extract and 25 ppm of hydroxytyrosol from olive extract before extrusion, then 7 ppm of carnosic acid from rosemary extract was applied through a fat coating.

For dogs, the food products tested were produced as follows:
M25 SA (positive control): The commercial formula M25 was mixed with 75 ppm of BHA before extrusion, then 50 ppm of BHA+17 ppm of PG+17 ppm of citric acid were applied through a fat coating.
M25 NA1G (positive control): The commercial formula M25 was mixed with 120 ppm of gamma and delta tocopherols from mixed tocopherols before extrusion, then 11 ppm of carnosic acid from rosemary extract was applied through a fat coating.
M25 NA2G: The commercial formula M25 was mixed with 22.5 ppm of gallotannins from gallnut extract and 25 ppm of hydroxytyrosol from olive extract before extrusion, and then 11 ppm of carnosic acid from rosemary extract was applied through a fat coating.

Each food product was produced 2 times in independent manner (2 production batches).

Storage of the Food Products

The food products were stored at Ambient conditions or Accelerated conditions either during a determined period.

Ambient conditions: storage at room temperature with 50% of relative humidity (RH).

Accelerated conditions: Storage at 40° C. with 50% of RH. Packaging: paper bags or controlled atmosphere bags (ATCO bags)

Study Design for Consumption Trials for Cats

The testing protocols used were paired comparison also known as “the two-bowl test”.

In this test, two cat food products (A and B) were served side by side in two identical bowls to n cats. The cats were able to choose freely between the two foods. At the end of the test period, the amount of each food consumed was measured. The two bowls test always assesses the palatability of one food relative to another. As the cats enrolled were known to be able to self-regulate their food intake, they were all fed ad libitum for 16 hours a day. During this time frame cats had the choice between two bowls of food. At the end of the feeding period, only cats that have eaten more than 10 g of product were considered in the results.

The consumption ratio is the percentage of each food eaten by a group of animals compared to the panel's total consumption. The ratio was calculated as shown below:

$$Ratio A = \frac{Consumption of food A}{Consumption of food A + Consumption of food B}$$

The consumption ratio was first calculated individually for each animal. Then the mean of the individual ratios was calculated to obtain the mean result for the group.

Study Design for Consumption Trials for Dogs

For dogs, two bowls of dog food products (A and B) were offered to each dog in the morning and in the afternoon for a pre-defined amount of time. The total amount of food in the 4 bowls (the 2 bowls fed in the morning+the 2 bowls fed in the afternoon) covered the maintenance energy requirements. Food preference was then determined by the first bowl to be finished observed by the animal caretaker.
1.2 Results

The presented results are the means of batch 1 and batch 2.
A. The natural antioxidant combination of the disclosure acts on the stability and preservation of the animal food products.
A.1 Accelerated Storage Conditions

TABLE 1
Peroxide Value mEq/kg fat and Hexanal ppm for cat food products

| | |
|---|---|
| PV | Hexanal |

| F32 | T0 | D 120 | T0 | D 120 |
|---|---|---|---|---|
| SA | 2.7 | 2.9 | 3 | 4.5 |
| SD | 0.1 | 0.1 | 0.8 | 0.4 |
| NA1G | 2.5 | 3.5 | 4.0 | 4.9 |
| SD | 0.4 | 0.6 | 1.0 | 0.7 |
| NA2G | 2.6 | 3.2 | 6.2 | 4.9 |
| SD | 0.4 | 0.5 | 1.8 | 0.9 |

TABLE 2
Peroxide Value mEq/kg fat and Hexanal
ppm for dog food products

| | |
|---|---|
| PV | Hexanal |

| M25 | T0 | D 120 | T0 | D 120 |
|---|---|---|---|---|
| SA | 2.3 | 4.8 | 2.9 | 5.5 |
| SD | 0.3 | 0.1 | 0.3 | 0.3 |
| NA1G | 2.2 | 5.9 | 3.0 | 6.8 |
| SD | 0.1 | 0.5 | 0.4 | 0.3 |
| NA2G | 2.5 | 5.0 | 3.1 | 7.3 |
| SD | 0.6 | 0.2 | 0.0 | 0.4 |

As shown in tables 1 and 2, the NA2G combination was equivalent to SA and NA1G for maintaining PV below 10 mEq/kg fat and Hexanal below 15 ppm for 120 days in accelerated storage conditions for cat and dog food products. Therefore, the NA2G was found to be a good new natural preservative food composition which is able to provide a good preservation of an animal food product.
A.2. Ambient Storage Conditions

TABLE 3
Peroxide Value mEq/kg fat and Hexanal
ppm (paper bags) for cat food products

| | |
|---|---|
| PV | Hexanal |

| F32 | T0 | M 12 | T0 | M 12 |
|---|---|---|---|---|
| SA | 2.7 | 4.2 | 3.0 | 5.1 |
| SD | 0.1 | 0.1 | 0.8 | 0.1 |
| NA1G | 2.5 | 2.9 | 4.0 | 5.6 |
| SD | 0.4 | 0.3 | 1.0 | 0.8 |
| NA2G | 2.6 | 2.7 | 6.2 | 9.4 |
| SD | 0.4 | 0.3 | 1.8 | 2.3 |

TABLE 4
Peroxide Value mEq/kg fat and Hexanal
ppm (ATCO bags) for cat food products

| | PV | | | Hexanal | | |
|---|---|---|---|---|---|---|
| F32 | T0 | M 12 | M 18 | T0 | M 12 | M 18 |
| SA | 2.7 | 2.2 | 1.8 | 3.0 | 2.4 | 2.6 |
| SD | 0.1 | 0.5 | 0.3 | 0.8 | 0.1 | 0.1 |
| NA1G | 2.5 | 3.5 | 1.8 | 4.0 | 3.6 | 3.0 |
| SD | 0.4 | 1.8 | 0.4 | 1.0 | 1.6 | 0.3 |
| NA2G | 2.6 | 2.1 | 2.3 | 6.2 | 2.6 | 3.3 |
| SD | 0.4 | 0.5 | ND | 1.8 | 0.2 | ND |

TABLE 5
Peroxide Value mEq/kg fat and Hexanal
ppm (paper bags) for dog food products

| | |
|---|---|
| PV | Hexanal |

| M25 | T0 | M 12 | T0 | M 12 |
|---|---|---|---|---|
| SA | 2.3 | 4.0 | 2.9 | 7.2 |
| SD | 0.1 | 1.3 | 0.3 | 2.5 |
| NA1G | 2.2 | 7.0 | 3.0 | 7.3 |
| SD | 0.1 | 1.3 | 0.4 | 0.6 |
| NA2G | 2.5 | 5.7 | 3.1 | 7.8 |
| SD | 0.6 | 0.3 | 0.0 | 1.0 |

TABLE 6
Peroxide Value mEq/kg fat and Hexanal
ppm (ATCO bags) for dog food products

| | PV | | | Hexanal | | |
|---|---|---|---|---|---|---|
| M25 | T0 | M 12 | M 18 | T0 | M 12 | M 18 |
| SA | 2.3 | 3.5 | 2.2 | 2.9 | 1.9 | 2.6 |
| SD | 0.3 | 1.2 | 0.2 | 0.3 | 0.1 | 0.0 |
| NA1G | 2.2 | 2.8 | 2.5 | 3.0 | 2.3 | 2.6 |
| SD | 0.1 | 0.6 | 0.3 | 0.4 | 0.2 | 0.2 |
| NA2G | 2.5 | 3.1 | 2.7 | 3.1 | 2.5 | 2.8 |
| SD | 0.6 | 1.2 | 0.1 | 0.0 | 0.3 | 0.1 |

As shown in tables 3 to 6, the NA2G combination was equivalent to SA and NA1G for maintaining PV below 10 mEq/kg fat and Hexanal below 15 ppm for 12 months in ambient conditions in paper bags and 18 months in ambient conditions in ATCO bags for cat and dog food products. Therefore, the NA2G combination was found to be a well new preservative food composition which shall trigger a good preservation of an animal food product.
B. The Natural Antioxidant Combination of the Disclosure Acts on the Palatability of the Animal Food Products

TABLE 7
Consumption of cat food products

| Time after | | Consumption ratio | Consumption ratio | | Cats |
|---|---|---|---|---|---|
| prod | | F32 SA | F32 NA2G | p-value | n= |
| 4 | months | 52.6% | 47.4% | 0.534 | 31 |
| | | | | (NS) | |
| 9 | months | 49.1% | 50.9% | 0.961 | 28 |
| | | | | (NS) | |
| 13 | months | 36.1% | 63.9% | <0.001 | 33 |
| | | | | (VHS) | |

TABLE 8
Consumption of dog food products

| Time after | Food Products | | Consumption | | | Dogs |
|---|---|---|---|---|---|---|
| prod | A | B | Ratio A | Ratio B | p-value | n= |
| 4 months | M25 | Pro Plan Dog Adult | 75% | 25% | <0.001 | 70 |
| | NA2G | Chicken & Rice | | | (VHS) | |
| 4 months | M25 | Hill's Adult Medium | 78% | 22% | <0.001 | 71 |
| | NA2G | chicken adv Fit | | | (VHS) | |
| 7 months | M25 | M25 SA | 66.9% | 33.1% | <0.001 | 72 |
| | NA2G | | | | (VHS) | |

As shown in tables 7 and 8, the organoleptic performance of a food product comprising the NA2G combination was equivalent or superior to a food product comprising the SA combination during shelf-life for cats and dogs. Further, it was shown in table 8 that food products comprising the NA2G combination were significantly more palatable than commercial food products (Pro Plan and Hill's products).

### Example 2

2.1 Materials and Methods

Peroxide Value and Hexanal Level

Food products as obtained were analyzed so as to determine the Peroxide Value (PV) and the Hexanal level (Hexanal). The Peroxide Value was determined according to the method for the iodometric determination of the peroxide value of fatty substances of animal and vegetable origin by visual detection at the end of the determination: NF EN ISO 3960 (Version of April 2017) or NF EN ISO 27107 (version of June 2010).

The Hexanal level was determined according to the AOCS method Cg 4-94 or according to the method described in the literature (Azarbad and Jelen, Determination of hexanal—an indicator of lipid oxidation by Static Headspace Gas Chromatography (SHS-GC) in Fat-Rich Food Matrices, Food Analytical Methods 8(7), 2014).

Commercial Formula Used in the Food Products

For cats, the first food products were based on the commercial formula ROYAL CANIN® Sensible 33 (S33). The second food products were based on the commercial formula ROYAL CANIN® Urinary feline moderate calorie (UMC).

For dogs, the first food products were based on the commercial formula ROYAL CANIN® Mobility (MOB). The second food products were based on the commercial formula ROYAL CANIN® Skin care small dog (SCD).

Antioxidant Combinations

Two antioxidant combinations were provided and tested throughout the example:
Synthetic antioxidants reference (SA) using BHA, PG and citric acid
New natural antioxidants combination (NA2G) using olive extract (hydroxytyrosol source), gallnut extract (hydrolysable tannin source) and rosemary extract (carnosic acid source).

Food Products

The preparation of an animal food product is well known by the skilled person.

For cats, the first food products tested were produced as follows:
S33 SA (positive control): The commercial formula S33 was mixed with 75 ppm of BHA before extrusion, and then 119 ppm of BHA+40 ppm of PG+40 ppm of citric acid were applied through a fat coating.
S33 NA2G: The commercial formula S33 was mixed with 22,5 ppm of gallotannins from gallnut extract and 25 ppm of hydroxytyrosol from olive extract applied before extrusion, and then 7 ppm of carnosic acid from rosemary extract was applied through a fat coating.

The second food products tested were produced as follows:
UMC SA (positive control): The commercial formula UMC was mixed with 75 ppm of BHA before extrusion, and then 25 ppm of BHA+9 ppm of PG+9 ppm of citric acid were applied through a fat coating.
UMC NA2G: The commercial formula UMC was mixed with 22,5 ppm of gallotannins from gallnut extract and 25 ppm of hydroxytyrosol from olive extract before extrusion, and then 7 ppm of carnosic acid from rosemary extract was applied through a fat coating.

For dogs, the first food products tested were produced as follows:
MOB SA (positive control): The commercial formula MOB was mixed with 75 ppm of BHA before extrusion, and then 32 ppm of BHA+11 ppm of PG+11 ppm of citric acid were applied through a fat coating.
MOB NA2G: The commercial formula MOB was mixed with 22,5 ppm of gallotannins from gallnut extract and 25 ppm of hydroxytyrosol from olive extract before extrusion, and then 11 ppm of carnosic acid from rosemary extract was applied through a fat coating.

The second food products tested were produced as follows:
SCD SA (positive control): The commercial formula SCD was mixed with 75 ppm of BHA before extrusion, and then 130 ppm of BHA+43 ppm of PG+43 ppm of citric acid were applied through a fat coating.
SCD NA2G: The commercial formula SCD was mixed with 22,5 ppm of gallotannins from gallnut extract and 25 ppm of hydroxytyrosol from olive extract before extrusion, and then 11 ppm of carnosic acid from rosemary extract was applied through a fat coating.

Each food product was produced 2 times in independent manner (2 production batches).

Storage Conditions of the Food Products

The food products were stored at Ambient conditions during a determined period.

Ambient storage conditions: storage at room temperature with 50% of RH.
Packaging: paper bags or controlled atmosphere bags (ATCO bags)
2.2 Results

The presented results are the means of batch 1 and batch 2.
A. The natural antioxidant combination of the disclosure acts on the stability and preservation of the animal food products.
A.1 Ambient storage conditions

TABLE 9
Peroxide Value (mEq/kg fat) and Hexanal (ppm)
for cat food products (paper bags - S33 & UMC)

| | S33 | T0 | T1 | T12 | UMC | T0 | T1 | T12 |
|---|---|---|---|---|---|---|---|---|
| PV | NA2G | 6.5 | 2.5 | 2.6 | NA2G | 7.2 | 4.9 | 4.8 |
| | SA | 4.9 | 2.6 | 2.1 | SA | 2.7 | 4.3 | 4.3 |
| Hexanal | NA2G | 4.6 | 3.6 | 6.4 | NA2G | 3.1 | 3.2 | 4.9 |
| | SA | 4.1 | 3.4 | 5.3 | SA | 2.7 | 3 | 4.4 |

TABLE 10
Peroxide Value (mEq/kg fat) and Hexanal (ppm)
for cat food products (ATCO bags - S33 & UMC)

| | S33 | T0 | T12 | T18 | UMC | T0 | T12 | T18 |
|---|---|---|---|---|---|---|---|---|
| PV | NA2G | 6.5 | 3.7 | 3.5 | NA2G | 7.2 | 6.5 | 4.8 |
| | SA | 4.9 | 2.7 | 1.7 | SA | 2.7 | 6.6 | 2.1 |
| Hexanal | NA2G | 4.6 | 6.4 | 4.5 | NA2G | 3.1 | 4.5 | 3.9 |
| | SA | 4.1 | 5.9 | 3.7 | SA | 2.7 | 4.2 | 2.8 |

TABLE 11
Peroxide Value (mEq/kg fat) and Hexanal (ppm)
for dog food products (paper bags - MOB & SCD)

| | MOB | T0 | T1 | T12 | SCD | T0 | T1 | T12 |
|---|---|---|---|---|---|---|---|---|
| PV | NA2G | 2.8 | 3.8 | 7.5 | NA2G | 4.3 | 3.2 | 4 |
| | SA | 7.1 | 8 | 15 | SA | 3.8 | 4.3 | 6.5 |
| Hexanal | NA2G | 2.8 | 3.1 | 6.3 | NA2G | 4.6 | 4.1 | 7.2 |
| | SA | 2.9 | 3.4 | 7.9 | SA | 4.1 | 4 | 7.5 |

TABLE 12
Peroxide Value (mEq/kg fat) and Hexanal (ppm)
for dog food products (ATCO bags - MOB & SCD)

| | MOB | T0 | T12 | T18 | SCD | T0 | T12 | T18 |
|---|---|---|---|---|---|---|---|---|
| PV | NA2G | 2.8 | 6.2 | 4.9 | NA2G | 4.3 | 4.1 | 3.6 |
| | SA | 7.1 | 12.8 | 6.2 | SA | 3.8 | 5.5 | 3.0 |
| Hexanal | NA2G | 2.8 | 7 | 6.6 | NA2G | 4.6 | 8.2 | 8.6 |
| | SA | 2.9 | 9.2 | 7.2 | SA | 4.1 | 8.1 | 8.9 |

As shown in tables 9 to 12, NA2G was equivalent to SA for maintaining PV below 10 mEq/kg fat and Hexanal below 15 ppm for 12 months in ambient conditions in paper bags and 18 months in ATCO bags for cat and dog food products. Therefore, an antioxidant combination comprising a carnosic acid source, a hydroxytyrosol source; and a tannin source, an ellagic acid source or a gallic acid source (NA2G) was found to be efficient to trigger the preservation of a food composition. Therefore, the NA2G was found to be a well new preservative food composition which shall trigger a good preservation of an animal food product.
B. The Natural Antioxidant Combination of the Disclosure Acts on the Palatability of the Animal Food Products

TABLE 13
Consumption of cat food products

| Time after | Consumption | Consumption ratio | | Cats |
|---|---|---|---|---|
| prod | ratio S33 SA | S33 NA2G | p-value | n= |
| 3 months | 53.9% | 46.1% | 0.331 | 29 |
| | | | (NS) | |
| 5 months | 43% | 57% | 0.048 | 34 |
| | | | (S) | |

| Time after | | Consumption | Consumption ratio | | Cats |
|---|---|---|---|---|---|
| prod | | ratio UMC SA | UMC NA2G | p-value | n= |
| 3.5 | months | 39.8% | 60.2% | 0.003 | 33 |
| | | | | (HS) | |
| 5 | months | 40.9% | 59.1% | 0.017 | 31 |
| | | | | (S) | |

TABLE 14
Preference of cat food products

| Time after | | Ratio S33 | Ratio S33 | | Cats |
|---|---|---|---|---|---|
| prod | Ratio S33 SA | NA2G | No Choice | p-value | n= |
| 3 months | 41% | 29% | 29% | 0.349 | 29 |
| | | | | (NS) | |
| 5 months | 22% | 41% | 37% | 0.067 | 34 |
| | | | | (NS) | |

| Time after | | Ratio UMC | Ratio UMC | Ratio UMC | | Cats |
|---|---|---|---|---|---|---|
| prod | | SA | NA2G | No Choice | p-value | n= |
| 3.5 | months | 21% | 45% | 33% | 0.024 | 33 |
| | | | | | (S) | |
| 5 | months | 26% | 45% | 29% | 0.097 | 31 |
| | | | | | (NS) | |

TABLE 15
Preference of dog food products

| Time after | Ratio MOB | Ratio MOB | Ratio MOB | p- | Dogs |
|---|---|---|---|---|---|
| prod | SA | NA2G | No Choice | value | n= |
| 5.5 months | 24% | 76% | 24% | <0.001 | 33 |
| | | | | (VHS) | |

| Time after | Ratio SCD | Ratio SCD | Ratio SCD | p- | Dogs |
|---|---|---|---|---|---|
| prod | SA | NA2G | No Choice | value | n= |
| 2.5 months | 49% | 51% | 22% | 0.847 | 34 |
| | | | | (NS) | |
| 5.5 months | 38% | 62% | 11% | 0.005 | 32 |
| | | | | (HS) | |

As shown in tables 13 to 15, the organoleptic performance of food products comprising the NA2G combination was equivalent or superior to food products comprising the SA combination during shelf-life for cat and dog food products.

Specifically, it was observed in table 13 that cat food products comprising NA2G combination were significantly more consume by cats at 3.5 or 5 months than food products comprising SA combination. Therefore, it has been observed that cat food products comprising a preservation food composition comprising a carnosic acid source, a hydroxytyrosol source; and a tannin source, an ellagic acid source or a gallic acid source were significantly more palatable than synthetic antioxidant combination.

Further, it was shown in tables 14 et 15 that food products comprising NA2G combination were significantly more preferred by cats and dogs at 3,5 months and 5,5 months, respectively, than food products comprising SA combination.

Therefore, it was observed that a preservative food composition including a carnosic acid source, a hydroxytyrosol source; and a tannin source of the disclosure was palatable for the animals.

### Example 3

3.1 Materials and Methods

Peroxide Value and Hexanal Level

Food products as obtained were analyzed so as to determine the Peroxide Value (PV) and the Hexanal level (Hexanal). The PV was determined according to the method for the iodometric determination of the peroxide value of fatty substances of animal and vegetable origin by visual detection at the end of the determination: NF EN ISO 3960 (Version of April 2017) or NF EN ISO 27107 (version of June 2010).

The Hexanal level was determined according to the AOCS method Cg 4-94 or according to the method described in the literature (Azarbad, Determination of hexanal—an indicator of lipid oxidation by HS-GC-FID in food matrices, 2014).

Formula Used in the Dry Food Products

The dry food products (kibbles) were based on a complete and balanced dry animal food formula comprising 25% of a dry animal protein source (duck meal), fat source, carbohydrate source, and other active ingredients. The dry protein source contained the following antioxidants:
Synthetic antioxidants reference (SA) (positive control): 80 ppm of BHA, 26 ppm of PG and 26 ppm of citric acid.
Natural antioxidants reference (NA1G) (positive control): 180 ppm of gamma and delta tocopherols and 30 ppm of carnosic acid;
New natural antioxidants combination (NA2G): 180 ppm of gamma and delta tocopherols and 30 ppm of carnosic acid.

Antioxidant Combinations

Three antioxidant combinations were provided and tested throughout the example:
Product SA based on BHA;
Product NA1G based on mixed gamma and delta (g+d) tocopherols;
Product NA2G based on olive extract, gallnut extract and pomegranate extract.

Dry Food Products and Production

The preparation of an animal dry food product (kibble) uses standard processes for pet food which are well known by the skilled person.

The dry food products tested in this example were prepared as follows:

The ingredients were received and stored at ambient temperature until use. Ingredients undergoing grinding were premixed using a paddle mixer for 2 minutes before they were ground in a hammermill (sieving at 0.8 mm). This ground blend and all other antioxidant ingredients, including olive and gallnut extracts for NA2G, were incorporated into a second mixer for final blending and mixing. This final blend was mixed in a paddle mixer for 5 minutes before being extruded under the following conditions: approximately 2.5 minutes at 100° C. in the conditioner and about 1 minute at 30kPa and 120° C. in the extruder.

Then half of the uncoated kibbles were stored in paper bags at ambient conditions and the remaining half uncoated kibbles dried (25 minutes at 90° C.) before being coated with fat and natural flavors (3,5 minutes at 60° C.) and rosemary extract for NA2G. Coated kibbles were then cooled to ambient temperature, typically 20 to 25° C. for about 30 minutes, and temporarily stored in silos (between 0 to 90 minutes) before being packed in paper bags, plastic bags, or aluminized plastic bags flushed with nitrogen, of different size.

The ingredients of the dry animal food formula with each antioxidant combinations were as follows:
Product SA (positive control): 75 ppm of BHA;
Product NA1G (positive control): 130 ppm of gamma and delta tocopherols;
Product NA2G: 32 ppm of carnosic acid, 10 ppm of ellagic acid (pomegranate extract) and 5 ppm of hydroxytyrosol (olive extract).

| | | Extrusion | |
|---|---|---|---|
| Diet | RMs | (uncoated) | Coating |
| SA | BHA 80 ppm + PG | BHA 75 ppm | Chicken fat without |
| | 26 ppm + citric acid | | antioxidant + liquid + |
| | 26 ppm in animal meal | | dry palatants |
| NA1G | g + d tocopherols 180 | g + d | chicken fat without |
| | ppm + carnosic acid | tocopherols | antioxidant + liquid + |
| | 30 ppm in animal meal | 130 ppm | dry palatants |
| NA2G | g + d tocopherols 180 | Ellagic acid | Carnosic acid 32 |
| | ppm + carnosic acid | 10 ppm, | ppm + chicken fat |
| | 30 ppm in animal meal | hydroxytyrosol | without antioxidant + |
| | | 5 ppm | liquid + dry palatants |

Each dry food product was produced 2 times in independent manner (2 production batches)

Storage of the Dry Food Products

The dry food products (uncoated and coated) were stored at Ambient conditions during a determined period.

Ambient storage conditions: storage at room temperature in paper bags with 50% of RH or storage in bags in a controlled atmosphere room (ATCO bags) with 50% of RH.
3.2 Results

The presented results are the means of batches.
A. The natural antioxidant combination NA2G of the disclosure acts on the stability and preservation of the coated dry animal food products

TABLE 16
Peroxide Value mEq/kg fat and Hexanal
ppm of uncoated dry food products

| | |
|---|---|
| PV | Hexanal |

| | T0 | D 90 | T0 | D 90 |
|---|---|---|---|---|
| SA | 5.4 | 22.9 | 2.9 | 3.7 |
| SD | ND | 3.6 | 0.4 | 1.0 |
| NA1G | 3.2 | 37.2 | 2.8 | 3.9 |
| SD | ND | 1.3 | 0.4 | 0.7 |
| NA2G | 3.6 | 23.7 | 3.2 | 3.8 |
| SD | 0.9 | 2.4 | 0.1 | 0.8 |

TABLE 17
Peroxide Value mEq/kg fat and Hexanal
ppm of coated dry food products

| | |
|---|---|
| PV | Hexanal |

| | T0 | M 12 | T0 | M 12 |
|---|---|---|---|---|
| SA | 4.1 | 7.4 | 3.6 | 9.5 |
| SD | 0.6 | 0.5 | 0.5 | 1.7 |
| NA1G | 5.6 | 9.5 | 3.4 | 11.2 |
| SD | 0.8 | 0.4 | 0.4 | 1.0 |
| NA2G | 3.4 | 9.1 | 4.0 | 11.8 |
| SD | 1.7 | 0.6 | 0.7 | 1.8 |

As shown in table 16, uncoated food products were not able to maintain PV below 10 mEq/kg fat however, uncoated food products maintain Hexanal below 15 ppm for 90 days in ambient conditions in paper bags.

As shown in table 17, coated food products comprising the NA2G combination were equivalent to food products comprising the SA combination for maintaining PV below 10 mEq/kg fat and Hexanal below 15 ppm for 12 months in ambient conditions in paper bags.

Therefore, blend of rosemary extract, olive extract and pomegranate extract (NA2G) use in kibble was as efficient as BHA or mixed tocopherols for maintaining PV below 10 mEq/kg fat and Hexanal below 15 ppm during 12 months in paper bags.

In conclusion, a food composition comprising an effective amount of a combination of a carnosic acid source, hydroxytyrosol source and at least one tannin source was found to be a new and more effective preservative food composition and can be used for an animal food product. Furthermore, a food composition comprising an effective amount of a combination of a carnosic acid source, hydroxytyrosol source and at least one tannin source was as efficient than food composition without tocopherol.

### Example 4

4.1 Material and Methods

The physiological parameter measured in the present example is the immune function: Lymphocyte proliferation assay.

Peripheral Blood Mononuclear Cells (PBMC) Proliferation

PBMC proliferation measures the ability of lymphocytes placed in short-term tissue culture to undergo a clonal proliferation when stimulated in vitro by a foreign molecule, antigen or mitogen. CD4+lymphocytes proliferate in response to antigenic peptides in association with class II major histocompatibility complex (MHC II) molecules on antigen-presenting cells (APCs).

This proliferative response of lymphocytes to antigen in vitro occurs only if the animal has been immunized to that antigen, either by having recovered from an infection with the microorganism containing that antigen, or by having been vaccinated. Therefore, some normal individuals cannot respond to a given antigen, but most animals will respond to at least one of several common microbial antigens.

Blood was used to analyse the mitogenic proliferative responsiveness of PBMCs to phytohemagglutinin (PHA, Sigma), Concavalin A (Con A, Sigma) and pokeweed mitogen (PWM, Sigma) to mimic in vivo conditions.

Heparinized blood was diluted in order to achieve 2.5, 5, 10, 20 μl blood/100 μl/well with the culture medium. All was done in triplicate, in 96-well flat bottom plates (200 μl total volume per well). The culture medium was RPMI1640+10% FCS, 4 mM L-Glutamine, 10 U/ml penicillin and 100 μg/ml streptomycin. Our preliminary studies using blood diluted to achieve 2,5, 5, 10, 20 μl blood /100 μl/well showed the best repeatability and optimal response to mitogens when using 5 μl of blood per well with ConA and PWM, and 2.5 μl of blood per well with PHA. Mitogens were tested at a concentration giving an intermediate effect between 50% and 95% of the maximum (EC50 and EC95):PWM 0.01 to 0.05 μg/ml, ConA 0.1 to 0.5 μg/ml, PHA 1 to 5 μg/ml. The mixture was incubated for 72 h at 37° C. in a humidified incubator under 5% CO2atmosphere. Eight hours prior to the termination of the incubation, 10 μl of [3H]-thymidine (1 μCi/well) was added. Tritiated thymidine uptake was measured by liquid scintillation and proliferative response of PBMCs was expressed as counts per minute (cpm) of stimulated cultures corrected for cpm of unstimulated cultures, as stimulation index (SI%). Analysis was made with GraphPrism software generating a variable slope four parameter curve fit. For each mitogen EC50 was calculated if possible.

Commercial Formula Used in the Animal Food Products

For dogs, the tested animal food products were based on ROYAL CANIN® Medium adult (M25) without non-essential “nutritional” antioxidants (green tea polyphenols, lutein . . . ). All raw materials were the same, and synthetically preserved (except a fat coating which did not contain antioxidant).

Antioxidants Combinations/Food Compositions Three antioxidant combinations were provided and tested throughout the example:
Wash-out diet based on low dosage synthetic preservation system, based on BHA and propyl gallate (PG).
Placebo diet (control) based on tocopherols.
Antioxidant 2G diet (test) based on gallnut extract (gallotannins), olive extract (hydroxytyrosol) and rosemary extract (carnosic acid).

Animal Food Products

The preparation of an animal food product is well known by the skilled person. The animal food products were a maintenance complete dry food, meeting minimum requirements of AAFCO (Association of American Feed Control Officials).

On table 18, precision on each preservation system for the 3 tested animal food products, with dosage of active compounds and application points in process.

TABLE 18
Preservation systems of experimental diets

| Diet | RMs | Extrusion | Coating |
|---|---|---|---|
| Wash-out | BHA 15 ppm + PG | BHA dry 4 ppm | No |
| | 4 ppm in animal meal | | Antioxidants |
| | | | applied |
| Placebo | BHA 15 ppm + PG | g + d | g + d |
| | 4 ppm in animal meal | tocopherols | tocopherols |
| | | 30 ppm | 30 ppm |
| Antioxidants | BHA 15 ppm + PG | Gallotannins | Carnosic acid |
| (2G) | 4 ppm in animal meal | 22.5 ppm + | 11 ppm |
| | | hydroxytyrosol | |
| | | 25 ppm | |

Finished products were packed in aluminized bags, containing oxygen scavenger sachets to reduce the differences of stability during storage due to preservation system differences.

Study Design

The tested animal food products were distributed according to energy requirements. Access to water was not restricted. Daily consumption was recorded for each dog.

The inclusion criteria for dogs were: (i) Various breed and races, (ii) Age: over 3 years, (iii) Good general health status, (iv) No pathologies, (v) No restrictions for the experimental diet.

The exclusion criteria for dogs were: (i) Pathologies declared before or during the study, (ii) Eating refusal.

Seventeen female dogs were fed with the same wash-out food product for 8 weeks.

Dogs were divided in 2 groups: Antioxidant 2G (test) and Placebo (control). The 2G or the Placebo food products, were then given for 8 weeks, followed by an 8 weeks wash-out period. Then 2G and Placebo groups were inversed for the last 8 weeks. Every 8 weeks, blood samples were taken, and physiological parameters were monitored to evaluate the effect of antioxidants combination, i.e., animal food products, on immune function. Thus, the study duration was 32 weeks.

Group 2G: 8 dogs and Placebo group: 9 dogs.

Statistical Analysis

Wilcoxon signed rank test was used to compare two related samples for the lymphocyte proliferation assay.
4.2 Results
4.2.1 Peripheral Blood Mononuclear Cells (PBMC) Proliferation

TABLE 19
Results for PBMC proliferation

| STIMULATION | | DIET | | | |
|---|---|---|---|---|---|
| INDEX | | Placebo | | 2G | |
| Mitogen | | | p | | p |
| dosage | Week | n = 9 | value | n = 8 | value |
| PWM 0.01 μg/ml | 0 | 1.97 ± 0.35 | 0.678 | 1.58 ± 0.19 | 0.020 |
| | 8 | 2.22 ± 0.45 | | 2.99 ± 0.51 | |
| PWM 0.05 μg/ml | 0 | 4.40 ± 0.78 | 0.515 | 2.86 ± 0.39 | 0.036 |
| | 8 | 3.83 ± 0.93 | | 4.73 ± 0.78 | |
| ConA 0.1 μg/ml | 0 | 1.38 ± 0.39 | 0.313 | 1.15 ± 0.15 | 0.049 |
| | 8 | 1.66 ± 0.35 | | 1.99 ± 0.44 | |
| ConA 0.5 μg/ml | 0 | 5.96 ± 1.75 | 0.767 | 3.75 ± 0.87 | 0.068 |
| | 8 | 4.43 ± 0.97 | | 5.99 ± 1.25 | |
| PHA 1 μg/ml | 0 | 1.21 ± 0.48 | 0.345 | 0.69 ± 0.18 | 0.028 |
| | 8 | 0.68 ± 0.07 | | 1.14 ± 0.24 | |
| PHA 5 μg/ml | 0 | 15.02 ± 10.35 | 0.123 | 3.73 ± 2.83 | 0.400 |
| | 8 | 1.39 ± 0.21 | | 4.65 ± 2.69 | |

mean ± SE
p value calculated with Wilcoxon test

15 The proliferative response of PBMCs was higher in 2G group than in the placebo group, after 8 weeks of consumption (Table 19).

Dogs fed 2G diet showed significantly higher proliferative response to PWM (at 0.01 μg/ml and 0.05 μg/ml), to ConA (at 0.1 μg/ml) and to PHA (at 1μg/ml) after 8 weeks.

Therefore, supplementation of hydroxytyrosol, gallotannins, and carnosic acid for 8 weeks leads to significant increase (p>0.05) of lymphocyte proliferation response to mitogen stimulation (PHA & Con A at low concentration and PWH at low & high concentration).

In summary, 2G antioxidant blend was found to positively modulate the immune response in healthy dogs.

### Example 5

5.1 Material and Methods

The physiological parameter measured in the present example was the immune function: Lymphocyte proliferation assay and vaccine response.
Peripheral Blood Mononuclear Cells (PBMC) Proliferation

PBMC proliferation measures the ability of lymphocytes placed in short-term tissue culture to undergo a clonal proliferation when stimulated in vitro by a foreign molecule, antigen or mitogen.

The method used involves isolating PBMCs, placing isolated cells in each well of a 96-well plate with or without various stimuli, and allowing the cells to proliferate for two days at 37° C. in a CO₂ incubator. The amount of proliferation was detected on the second day by adding yellow tetrazolium MTT (3-(4,5-dimethylthiazolyl-2)-2,5-diphenyltetrazolium bromide) for 4 hours. MTT was reduced by metabolically active cells, in part by the action of dehydrogenase enzymes, to generate reducing equivalents such as NADH and NADPH. The resulting intracellular purple formazan could then be solubilized and quantified by spectrophotometric means at 560 nm and 690 nm. This is proportional to the number of proliferating cells, which in turn is a function of the number of lymphocytes that were stimulated by a given mitogen to enter the proliferative response.

Mitogens used are Concanavalin A (Con A 5 and 1 μl/ml for dogs, 2.5 and 0.25 μl/ml for cats), PhytoHemaglutinin A (PHA 20 and 2 μl/ml for dogs, 1.25 and 0.25 μl/ml for cats), PokeWeed Mitogen (PWM 2 and 0.25 μl/ml for dogs, 0.25 and 0.05 μl/ml for cats).

Commercial Formula Used in the Animal Food Products

For dogs, the tested animal food products were based on ROYAL CANIN® Medium adult (M25) without non-essential “nutritional” antioxidants (green tea polyphenols, lutein . . . ).

For cats, the tested animal food products were based on ROYAL CANIN ® FIT 32 (F32) without non-essential “nutritional” antioxidants (green tea polyphenols, lutein . . . ).

All raw materials were the same, and synthetically preserved (except for the fat coating, which did not contain any antioxidants).

Antioxidant Combinations

Three antioxidant combinations were provided and tested throughout the example:
Wash-out diet no preservative added.
Placebo diet (control) no preservative added.
Antioxidant 2G (test) based on gallnut extracts (gallotannins combination), olive extract (hydroxytyrosol) and rosemary extract (carnosic acid).

Animal Food Products

The preparation of an animal food product is well known by the skilled person. The animal food products were a maintenance complete dry food, meeting minimum requirements of AAFCO (Association of American Feed Control Officials).

On Table 20, precision on each preservation system for the 3 tested animal food products, with dosage of active compounds and application points in process. Only the dosage for carnosic acid was different whether it was cats or dogs.

TABLE 20
Preservation systems of tested animal
food product for cats and dogs

| | RMs (M25 for dogs, | | |
|---|---|---|---|
| Diet | F32 for cats) | Extrusion | Coating |
| Wash-out | BHA 15 ppm + PG 4 | No Antioxidant | No Antioxidant |
| | ppm in animal meal | applied | applied |
| Control | BHA 15 ppm + PG 4 | No Antioxidant | No Antioxidant |
| (Placebo) | ppm in animal meal | applied | applied |
| Antioxidants | BHA 15 ppm + PG 4 | Gallotannins | Carnosic acid |
| (2G) | ppm in animal meal | 22.5 ppm + | 11 ppm (M25) |
| | | hydroxytyrosol | Carnosic acid |
| | | 25 ppm | 7 ppm (F32) |

Finished products were packed in aluminized bags, containing oxygen scavenger sachets to reduce the differences of stability during storage due to preservation system differences.

Study Design for Dogs

The inclusion criteria were: (i) Various breed and races, (ii) Age: over 3 years, (iii) Good general health status, (iv) No pathologies, (v) No restrictions for the experimental diet, (vi) Gender male and female, (vii) Weight: over 7 kg, (viii) no current medication, including systemic steroidal or non-steroidal anti-inflammatory therapies.

The exclusion criteria were: (i) Pathologies declared before or during the study, (ii) Eating refusal, (iii) Dogs that have been vaccinated in the last 6 months before the study.

Thirty healthy dogs were fed with the wash-out food product (based on M25) for 4 weeks.

After the 4 weeks, dogs were divided in 2 groups: Antioxidant 2G (test) and Placebo (control). The 2G or the Placebo food product, were then given for 40 weeks. Blood collection on fasted dogs was collected on week 12, 14, 16, 18, 20, 28, 36 and 44. A vaccination with rabies vaccine was realized at week 12 after blood collection scheduled at this time.

2G group: 15 dogs and Placebo group: 15 dogs.

TABLE 21
Study design for cats

| | | | | 40 weeks | | | | |
|---|---|---|---|---|---|---|---|---|
| | 4 weeks | | | 2G food product | | | | |
| | Wash-out diet | | | Placebo food product | | | | |
| Blood | Week | W 2 | W 4 | W 12 + W 14 + | W 20 | W 28 | W 36 | W 44 |
| collection | (W) 0 | | | W 16 + W 18 + | | | | |
| | | | | vaccination | | | | |
| | | | | (W 12) | | | | |

The inclusion criteria for cats were: (i) Various breed and races, (ii) Age: over 3 years, (iii) Good general health status, (iv) No pathologies, (v) No restrictions for the experimental diet, (vi) Gender male and female, (vii) no current medication, including systemic steroidal or non-steroidal anti-inflammatory therapies.

The exclusion criteria were: (i) Pathologies declared before or during the study, (ii) Eating refusal, (iii) cats that have been vaccinated in the last 6 months before the study.

Twenty-one healthy cats were fed with the wash-out food product (F32 for cats) for 4 weeks.

Cats were divided in 2 groups: Antioxidant 2G (test) and Placebo (control). The 2G or the Placebo food product, were then given for 40 weeks. Blood collection on fasted cats were collected on week 0. 2, 4, 12, 14, 16, 18, 20, 28, 36 and 44.

Mitogens used were Concavalin A (Con A) at 0.25 μg/ml, referred to low concentration.
2G group: 10 cats and Placebo group: 11 cats.
Statistical Analysis

Mixed models were used to test the impact of time (from 2 to 9 Levels), food product (2 levels) and the respective interaction on all measured parameters. Dog effect was modelled as a random term. Maximum likelihood estimation was based on Restricted Maximum Likelihood methods (REML methods).
Residual distributions were checked, and mathematical transformations could be used if appropriate. P values were adjusted by Scheffe's method to avoid alpha risk inflation. Level of significance was set at 5%.
5.2 Results
5.2.1 Lymphocyte Pproliferation in Dogs

There was a significant difference in stimulation index of lymphocyte when using PHA at low dosage, ConA at low dosage and PWM at high dosage between groups and over time (Table 22). Stimulation index was higher at week 12 than at week 4 in the 2G group. Stimulation index at week 12 in 2G group was also higher than in the Placebo group. After 12 weeks and following vaccination, values between groups get normalized as expected. PHA and ConA indicated a stimulation of lymphocyte T, while PMW indicated a stimulation of lymphocyte B and T.

TABLE 22
Results for stimulation index of lymphocyte in dog

| | | Stimulation Index | | | | | | | | | | |
|---|---|---|---|---|---|---|---|---|---|---|---|---|
| | | 2G group | | | | Control group | | | | p-value | | |
| | | Week (W) 4 | W 12 | W 20 | W 44 | W 4 | W 12 | W 20 | W 44 | Diet | Time | Diet * Time |
| | N dogs | 15 | 14 | 14 | 14 | 15 | 15 | 15 | 14 | | | |
| PHA High | Mean | 0.955 | 1.569 | 1.224 | 1.258 | 1.178 | 1.404 | 1.258 | 1.257 | 0.8179 | 0.0018 | 0.3212 |
| Dose | Std Err | 0.088 | 0.134 | 0.135 | 0.067 | 0.093 | 0.134 | 0.109 | 0.116 | | | |
| PHA Low | Mean | 0.942 | 1.633 | 1.212 | 1.115 | 1.293 | 1.459 | 1.369 | 1.108 | 0.1929 | <0.0001 | 0.0247 |
| Dose | Std Err | 0.091 | 0.077 | 0.116 | 0.057 | 0.089 | 0.101 | 0.089 | 0.066 | | | |
| ConA High | Mean | 1.328 | 1.921 | 1.676 | 1.620 | 1.526 | 1.876 | 1.642 | 1.745 | 0.6684 | 0.0049 | 0.7189 |
| Dose | Std Err | 0.132 | 0.167 | 0.182 | 0.095 | 0.111 | 0.144 | 0.103 | 0.183 | | | |
| ConA Low | Mean | 1.490 | 2.337 | 1.680 | 1.661 | 1.696 | 1.912 | 1.833 | 1.445 | 0.5886 | <0.0001 | 0.0327 |
| Dose | Std Err | 0.154 | 0.190 | 0.133 | 0.115 | 0.117 | 0.130 | 0.121 | 0.126 | | | |
| PWM High | Mean | 0.868 | 1.560 | 1.083 | 1.174 | 1.189 | 1.301 | 1.042 | 1.102 | 0.881 | 0.0005 | 0.0398 |
| Dose | Std Err | 0.101 | 0.104 | 0.119 | 0.085 | 0.112 | 0.109 | 0.088 | 0.128 | | | |
| PWM Low | Mean | 1.309 | 1.825 | 1.345 | 1.261 | 1.540 | 1.595 | 1.248 | 1.169 | 0.6458 | 0.0005 | 0.2593 |
| Dose | Std Err | 0.157 | 0.114 | 0.098 | 0.093 | 0.169 | 0.124 | 0.102 | 0.110 | | | |

5.2.2 Vaccine Response with Rabies Booster Vaccine in Dogs

All dogs were administered a rabies booster vaccine at week 12, after blood collection, which represent the baseline of each animal initially. Blood samples were analyzed every 2 weeks until week 20, and then every 8 weeks until week 44. Rabies antibodies reached a peak after 2 weeks in both groups, indicating a response to the vaccination.

In the 2G group rabies antibodies declined less quickly than for the control group (Table 23). Dogs in the 2G group exhibited a significantly higher vaccine response to rabies when compare to the control group over time (Table 24).

TABLE 23
Results for post-vaccine immune response with rabies booster vaccine

| | | | W 12 | W 14 | W 16 | W 18 | W 20 | W 28 | W 36 | W 44 |
|---|---|---|---|---|---|---|---|---|---|---|
| Rabies | 2G | Mean | 2.800 | 20.893 | 20.386 | 10.986 | 15.485 | 7.929 | 6.336 | 6.507 |
| (IU/ml) | | SE | 0.977 | 4.221 | 8.002 | 1.862 | 7.144 | 1.524 | 1.217 | 1.065 |
| mod | Placebo | Mean | 2.587 | 11.600 | 4.767 | 7.200 | 5.313 | 6.986 | 4.964 | 5.221 |
| | | SE | 2.042 | 4.693 | 2.009 | 3.949 | 2.950 | 5.415 | 3.370 | 3.206 |

TABLE 24
Statistical results vaccine response 2G group vs. Placebo group
Method Linear Mixed Model - Log transformed

| Effects | p-values |
|---|---|
| Diet | 0.0049 |
| Time | <.0001 |
| Diet × Time | 0.0161 |

Therefore, supplementation of 2G food composition (hydroxytyrosol 25 ppm, tannic/gallic acid 22,5 ppm and carnosic acid 11 ppm) for 40 weeks was shown to promote an immune response to rabies vaccination over time, through an increase in rabies specific neutralizing antibodies.
5.2.3 Lymphocyte Proliferation Assay in Cats

There was a significant difference in stimulation index of lymphocyte when using PHA at low and high dosage, ConA at low and high dosage between groups and over time (Table 25). Stimulation index was higher at week 12 than at week 4 in the 2G group. Stimulation index at week 12 in 2G group was also higher than in the Placebo group. After 12 weeks and following vaccination, values between groups were normalized as expected. PHA and ConA indicated a stimulation of lymphocyte T.

TABLE 25
Statistical results for PBMC proliferation when using Con

| | | Stimulation Index | | | | | | | | | | |
|---|---|---|---|---|---|---|---|---|---|---|---|---|
| | | 2G group | | | | Control group | | | | p-value | | |
| | | W 4 | W 12 | W 20 | W 44 | W 4 | W 12 | W 20 | W 44 | Diet | Time | Diet * Time |
| PHA High | Mean | 0.757 | 1.512 | 1.350 | 1.243 | 0.824 | 1.133 | 1.359 | 1.400 | 0.6 | <0.0001 | 0.0428 |
| Dose | Std Err | 0.099 | 0.102 | 0.135 | 0.106 | 0.086 | 0.100 | 0.067 | 0.086 | | | |
| PHA Low | Mean | 0.714 | 1.594 | 1.520 | 1.328 | 0.719 | 1.152 | 1.416 | 1.488 | 0.101 | <0.0001 | 0.0038 |
| Dose | Std Err | 0.079 | 0.075 | 0.126 | 0.081 | 0.058 | 0.045 | 0.044 | 0.108 | | | |
| ConA High | Mean | 1.091 | 2.033 | 1.476 | 1.426 | 1.262 | 1.565 | 1.571 | 1.539 | 0.8297 | <0.0001 | 0.0358 |
| Dose | Std Err | 0.131 | 0.115 | 0.140 | 0.105 | 0.150 | 0.155 | 0.067 | 0.131 | | | |
| ConA Low | Mean | 0.738 | 1.796 | 1.626 | 1.306 | 0.718 | 1.346 | 1.619 | 1.388 | 0.1526 | <0.0001 | 0.0346 |
| Dose | Std Err | 0.089 | 0.079 | 0.135 | 0.102 | 0.058 | 0.058 | 0.082 | 0.136 | | | |
| PWM High | Mean | 0.796 | 1.454 | 1.335 | 1.088 | 0.732 | 1.149 | 1.447 | 1.204 | 0.8282 | <0.0001 | 0.1898 |
| Dose | Std Err | 0.122 | 0.076 | 0.160 | 0.089 | 0.066 | 0.069 | 0.145 | 0.076 | | | |
| PWM Low | Mean | 0.748 | 1.566 | 1.605 | 1.171 | 0.785 | 1.228 | 1.562 | 1.253 | 0.3855 | <0.0001 | 0.0906 |
| Dose | Std Err | 0.113 | 0.082 | 0.114 | 0.076 | 0.062 | 0.051 | 0.121 | 0.103 | | | |

In conclusion, the experimental data show that a food composition comprising at least a combination of an effective amount of a carnosic acid source, a hydroxytyrosol source, and at least one of a tannin source, an ellagic acid source or a gallic acid source elicits the immune response of an animal. In other words, the food composition of the present disclosure induces a significant beneficial modulation of immune function for an animal.

### Example 6

6.1 Material and Methods

The physiological parameters measured in the present example were local immunity and intestinal inflammation. A key strategy of intestinal immune protection is the production of immunoglobulin A (IgA), the most abundant antibody isotype produced in the body, although it is the second most dominant isotype in the circulation after IgG. IgA is largely produced in mucosal lymphoid tissues and plays important roles in mucosal immunity.

Canine calprotectin, the S100A8/A9 protein complex, and also S100Al2 (also known as Calgranulin C) are Ca2+-binding proteins of the S100/calgranulin family that have been shown to be associated with acute and chronic inflammation and with malignant transformation. These proteins are involved in the regulation of cell proliferation and metastasis, and after their extracellular release function as endogenous danger-signaling molecules (alarmins). Calprotectin and S100Al2 have potential as markers of inflammation in dogs. Fecal calprotectin and S100Al2 have been shown to be correlated with some clinical disease activity. Fecal calprotectin, S100Al2 and IgA are useful markers to evaluate intestinal inflammation or local immunity.

The study design, the food products and the antioxidants combination used in this example were the same as the one used and described in the previous example 5 for dogs.

Fecal samples were harvested at weeks 20, 28, 36 and 44 during 3 consecutive days at each week. Samples were taken either individually for each dogs or pooled for two dogs (within the same group) when housed in pairs. Samples were frozen and send to laboratory for analysis.
6.2 Results

Results hereafter have been analyzed per group over the whole period of time considered using average of results for 3 consecutive days.

Fecal IgA was significantly lower in the 2G diet group than in the control group over the whole period of time (Wilcoxon/Kruskal-Wallis test, p=0.0173). Fecal IgA ranged from 0.11 to 15,09 mg/g feces in the 2G diet group and from 0.15 to 21,22 mg/g feces in the control group. Medians in 2G and control groups were respectively 0.675 and 1.36 mg/g feces.

Fecal calprotectine was significantly lower in the 2G diet group than in the control group over the whole period of time (Wilcoxon/Kruskal-Wallis test, p=0.0142). Fecal calprotectin ranged from 0.37 to 22,57 μg/g feces in the 2G diet group and from 0.37 to 58.9 μg/g feces in the control group. Medians in 2G and control groups were respectively 0.41 and 0.59 μg/g feces.

Fecal S100A12 was significantly lower in the 2G diet group than in the control group over the whole period of time (Wilcoxon/Kruskal-Wallis test, p=0.0178). Fecal S100A12 ranged from 1.00 to 8952.86 ng/g feces in the 2G diet group and from 1.67 to 15390.14 ng/g feces in the control group. Medians in 2G and control groups were respectively 11.56 and 21.24 ng/g feces.
6.2.1 Fecal Immunoglobulin A

TABLE 26
Statistical results for the Fecal IgA in mg per g of feces

| | | | | Std | | | | | | | | | | |
|---|---|---|---|---|---|---|---|---|---|---|---|---|---|---|
| | | | Std | Err | | | | | | | | | | |
| Level | Nbr | Mean | Dev | Mean | <95% | >95% | Min. | 10% | 25% | 50% | 75% | 90% | Max. | P value |
| 2G | 64 | 1.77 | 2.79 | 0.35 | 1.07 | 2.47 | 0.11 | 0.23 | 0.355 | 0.675 | 1.5225 | 5.88 | 15.09 | 0.0173 |
| Placebo | 67 | 2.80 | 4.13 | 0.51 | 1.79 | 3.81 | 0.15 | 0.27 | 0.45 | 1.36 | 2.78 | 8.656 | 21.22 | |

6.2.2 Fecal Calprotectine

TABLE 27
Statistical results for the Calprotectin IgA in μg per g of feces

| | | | Std | Std Err | | | | | | | | | | |
|---|---|---|---|---|---|---|---|---|---|---|---|---|---|---|
| Level | Nbr | Mean | Dev | Mean | <95% | >95% | Min | 10% | 25% | 50% | 75% | 90% | Max | P value |
| 2G | 64 | 2.20 | 4.93 | 0.62 | 0.97 | 3.43 | 0.37 | 0.37 | 0.37 | 0.41 | 0.84 | 7.86 | 22.57 | 0.0142 |
| Placebo | 67 | 3.63 | 8.80 | 1.07 | 1.48 | 5.77 | 0.37 | 0.37 | 0.38 | 0.59 | 1.79 | 11.35 | 58.9 | |

6.2.3 Fecal S100A12

TABLE 28
Statistical results for the Fecal S100A12 in ng per g of fece

| | | | | Std Err | | | | | | | | | | P |
|---|---|---|---|---|---|---|---|---|---|---|---|---|---|---|
| Level | Nbr | Mean | Std Dev | Mean | <95% | >95% | Min | 10% | 25% | 50% | 75% | 90% | Max | value |
| 2G | 64 | 325.26 | 1545.92 | 193.24 | 60.90 | 711.42 | 1.00 | 1.68 | 6.26 | 11.56 | 32.05 | 289.21 | 8952.86 | 0.0178 |
| Placebo | 67 | 513.26 | 2432.77 | 297.21 | 80.14 | 1106.66 | 1.75 | 5.16 | 8.89 | 21.24 | 61.65 | 566.6 | 15390.14 | |

6.2.4 Conclusion

Fecal parameters showed were significantly lower in the 2G diet group for IgA, calprotectin, and S100A12 indicating that supplementation of 2G food composition (hydroxytyrosol 25 ppm, 10 tannic/gallic acid 22.5 ppm and carnosic acid 11 ppm) for 40 weeks would have a beneficial impact on local immunity and intestinal inflammation in dogs.

Although the presently disclosed subject matter and its advantages have been described in detail, it should be understood that various changes, substitutions and alterations can be made herein without departing from the spirit and scope of the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

For any patents, patent applications, publications, product descriptions, and protocols are cited throughout this application, the disclosures of all of which are incorporated herein by reference in their entireties for all purposes.

1. A food composition comprising a combination of an effective amount of:
(i) a carnosic acid source;
(ii) a hydroxytyrosol source; and
(iii) a tannin source.

2. The food composition according to claim 1, wherein the tannin source is present in an amount of less than about 40 ppm.

3. The food composition according to claim 1, wherein the (i) carnosic acid source, (ii) hydroxytyrosol source and (iii) tannin source are each present in an amount of less than about 40 ppm.

4. The food composition according to claim 1, wherein the (i) carnosic acid source, (ii) hydroxytyrosol source and (iii) tannin source are each present in an amount ranging from about 3 ppm to less than about 40 ppm.

5. The food composition according to claim 1, wherein the tannin source is a hydrolysable tannin source.

6. The food composition according to claim 1, wherein the tannin source is a gallotannin source, an ellagitannin source, or a combination thereof.

7. The food composition according to claim 1, wherein the tannin source is a tannic acid source, a gallic acid source, an ellagic acid source, or a combination thereof.

8. The food composition according to claim 1, wherein the tannin source is a combination of a tannic acid source.

9. The food composition according to claim 1, wherein the tannin source is a combination of a tannic acid source and a gallic acid source with a tannic acid:gallic acid ratio ranging from about 1:5 to about 1:50.

10. The food composition according to claim 1, which does not comprise tocopherol.

11. The food composition according to claim 1, characterized in that it is a functional food, a dietary, a food additive, a food preservative, a supplement, a drug, a foodstuff, or a nutritionally complete food composition.

12. A companion animal food product comprising a food composition according to claim 1.

13. The companion animal food product according to claim 12, which does not comprise tocopherol.

14. A kit for the preparation of a companion animal food product, comprising:
(i) a carnosic acid source;
(ii) a hydroxytyrosol source; and
(iii) a tannin source.

15. (canceled)

16. (canceled)

17. (canceled)

18. (canceled)

19. (canceled)

20. A method for maintaining the PV (Peroxide Value) of a companion animal food product, said method comprising the step of bringing into contact the said companion animal food product with a combination of (i) a carnosic acid source; (ii) a hydroxytyrosol source; and (iii) a tannin source.

21. The method according to claim 20, wherein the PV of the companion animal food product is below 10 mEq/kg fat for at least 12 months.

22. The method according to claim 20, wherein, (i) the carnosic acid source is in an amount of less than about 40 ppm, (ii) the hydroxytyrosol source is in an amount of less than about 40 ppm, and (iii) a tannin source is in an amount of less than about 40 ppm.

23. A method for maintaining the hexanal value of a companion animal food product, said method comprising the step of bringing into contact the said companion animal food product with a combination of (i) a carnosic acid source; (ii) a hydroxytyrosol source; and (iii) a tannin source.

24. The method according to claim 23, wherein the hexanal value of the companion animal food product is below about 15 ppm for at least about 12 months.

25. The method according to claim 23, wherein (i) the carnosic acid source is in an amount of less than about 40 ppm, (ii) the hydroxytyrosol source is in an amount of less than about 40 ppm, and (iii) the tannin source is in an amount of less than about 40 ppm.

26. (canceled)

27. (canceled)

28. (canceled)

29. (canceled)
